(19) United States
(12) Patent Application Publication
(10) Pub. No.: US 2015/0269522 A1
(43) Pub. Date: Sep. 24, 2015

(54) SYSTEM AND METHOD FOR SHARING DILIGENCE INFORMATION RELATED TO AN INVESTMENT FUND

(71) Applicant: ASPN Solutions, LLC, New York, NY (US)

(72) Inventor: Jeffrey TARRANT, New York, NY (US)

(73) Assignee: ASPN Solutions, LLC, New York, NY (US)

(21) Appl. No.: 14/222,315

(22) Filed: Mar. 21, 2014

(51) Int. Cl. G06Q 10/10

(52) U.S. Cl. CPC G06Q 10/10

(57) ABSTRACT

A fund management system may facilitate sharing diligence information related to an investment fund with a client, a manager of another fund, a third party and/or other trusted party. The fund management system may enable one or more levels of restricted access to a fund and its associated documents. The fund management system may allow a fund manager, administrator, and/or other fund-level entity to restrict access to information about funds, information about a document of a fund, and/or other information. The fund management system may allow an author of a document to share the document with a trusted party, where that trusted party may have access to information about the document but may not be able to access the document itself. Responsive to an author sharing a document with a trusted party, the fund management system may share the documents of the trusted party with the author.

### RELATED APPLICATIONS

This application is related to Attorney Docket No. 023113-0421856, entitled, “SYSTEM AND METHOD FOR DETERMINING AN INVESTMENT THEME FOR A POTENTIAL INVESTMENT FUND;” and Attorney Docket No. 023113-0429820, entitled “SYSTEM AND METHOD FOR ANONYMOUSLY IDENTIFYING MEMBERS OF A SYNDICATE FOR AN INVESTMENT THEME,” both of which are incorporated by reference herein in their entireties.

### FIELD OF THE INVENTION

The invention relates to a system and method for sharing diligence information related to an investment fund, such that an author of a document related to an investment fund may share one or more portions of the document with a client, a manager of a fund, a manager of another fund, and/or other trusted party.

### BACKGROUND OF THE INVENTION

Generally speaking, determining a strategy for an investment fund, and managing that investment fund, involves interaction between persons in various roles. A manager of a fund may work with one or more analysts to create and manage the fund. Consulting companies that provide information regarding the investment fund, potential asset allocators of the fund, clients who provide money to be managed via an investment fund, and/or other third parties may also be interested in information related to diligence activities for an investment fund. Also, managers and analysts of other firms may be curious as to performance of and/or diligence performed for the investment fund. A firm and/or managers involved with a fund may share diligence and performance information for an investment fund with other managers and/or analysts in the firm, and/or other parties.

Conventional fund management tools may exist, but have various limitations and drawbacks. Depending with whom a document for an investment fund is shared, a manager or analyst sharing the information may need to redact parts of the document, may make all of the document available, may only make commentary related to the document available, and/or otherwise manually restrict how the document is shared. The decision of how much information to share may be solely at discretion of the person (e.g., manager or analyst) sharing the information. Further, the information that is not shared from the document may need to be manually redacted on a case-to-case basis based on the party with whom the document is being shared. These and other drawbacks exist.

### SUMMARY OF THE INVENTION

The disclosure relates to a system and method for investment fund management that is configured to facilitate sharing, via a fund management portal, diligence information for a plurality of funds.

A plurality of investment firms may use the fund management system to share diligence information related to investment funds managed by the individual firms. In one example, a first firm administrator of a first firm, a first set of managers of the first firm, a first set of analysts of the first firm, a first set of clients of the first firm, a first set of third parties that work with the first firm, and/or other users associated with the first firm may access the fund management system. A firm administrator of a second firm, a second set of managers of the second firm, a second set of analysts of the second firm, a second set of clients (which may or may not overlap with the first set of clients), a second set of third parties that work with the second firm (which may or may not overlap with the first set of third parties) may also use and access the fund management system.

The fund management system may facilitate management of the research performed in relation to investment funds by various firms. That research may include the creation, editing, sharing, and/or other management of numerous documents related to the research. The documents may be, for example, documents that comprise diligence information determined for an investment fund, notes about meetings, presentations, and/or other events related to an investment fund, performance reports and/or other reports related to the execution of the investment fund, and/or other documents involved in initiating, running, and/or otherwise managing an investment fund.

A document managed by the fund management system may be associated with a particular fund, as well as with author(s) of the document, manager(s) associated with the fund, an administrator of the firm managing the fund, and/or other related entities. In some implementations, a document may also be associated with a client of the fund, third parties involved in the research, performance, and/or other management of the fund, and/or other entities.

Some or all of the information in a document may be proprietary. As such, the fund management system may enable one or more levels of restricted access to a fund and its associated documents. For example, the fund management system may allow a fund manager, fund administrator, system administrator, and/or other fund-level entity to restrict access to information about funds, information about a document of a fund, and/or other information.

The fund management system may allow a fund-level entity to set fund permissions for a fund. The fund permissions may comprise a plurality of fund permission settings including, for example, a fund indicator, a set of document type indicators, a set of document rules, and/or other permissions related to access of the fund. The fund indicator may comprise an indication of whether any information related to the fund may be shared with entities outside of the managers, analysts, and/or other users identified with the fund. An individual document type indicator of the set of document type indicators may comprise an indication of whether a document of a corresponding document type may be shared with entities outside of the managers, analysts, and/or other users identified with the fund. An individual document rule of the set of document rules may comprise an indication of whether a particular document may be shared with entities outside of the managers, analysts, and/or other users identified with the fund. In some implementations, a document rule may also comprise a set of portion rules. An individual portion rule of the set of portion rules may comprise an indication of whether a particular portion of the document may be shared with entities outside of the managers, analysts, and/or other users identified with the fund.

In some implementations, the set of fund permissions, and/or each element of the set of fund permissions, may comprise a user list including a list of entities outside of the managers, analysts, and/or other users identified with the fund with whom information related to the fund may be shared.

Based on the set of fund permissions for a fund, entities not previously associated with the fund may be allowed access to information related to the fund, information related to one or more documents of the fund, and/or other related information. For example, fund permissions may be set such that all managers of a firm may be allowed access to information and documents of each fund associated with the firm. In another example, fund permissions may be set such that a client may be allowed access to certain information and documents of a fund in which they have invested.

The fund management system may allow an author of a document associated with a fund to share the document with an entity that is not previously associated with the fund via the fund management system, where that entity may have access to information about the document (based on the set of fund permissions for the fund) but may not be able to access the document itself. The fund management system may allow an author of a document to set author permissions for the document, whereby another level of restricted access may be provided to entities based on the author permissions.

The author permissions for a document may comprise a plurality of author permission settings including, for example, a document indicator, a set of portion rules, and/or other permissions related to access of the fund. A document indicator for a particular document may comprise an indication of whether the particular document may be shared with entities outside of the managers, analysts, and/or other users identified with the fund. An individual portion rule of the set of portion rules may comprise an indication of whether a particular portion of the document may be shared with entities outside of the managers, analysts, and/or other users identified with the fund. In some implementations, the author rule may also comprise a version rule indicating whether a document labeled as a draft version (instead of a final version) may be shared with entities outside of the managers, analysts, and/or other users identified with the fund.

In some implementations, the author permissions, and/or components of the author permissions, may also comprise a corresponding user list including a list of entities (and/or user roles) outside of the managers, analysts, and/or other users identified with the fund associated with the document with whom information related to the document may be shared.

Responsive to a determination that an author wants to share documents with another entity, the fund management system may send a request to the other entity with the request to share documents. Responsive to the other entity accepting the request, the fund management system may share the documents of the other entity with the author as well. The documents that are shared between the author and the other entity may be selected by each individual user, may be delineated by fund, may be delineated by document type, and/or may be determined based on other criteria. User list(s) associated with author permissions for the shared document(s) may be updated based on the acceptance of the request.

The fund management system may allow users with whom documents are shared to rate the documents, rate the author(s) of the document, rate the fund associated with the document, rate the firm associated with the document, and/or provide other ratings. The fund management system may provide an author of the document with ratings, feedback, and/or other information provided by a user with whom the document was shared. The fund management system may aggregate ratings for documents, authors, funds, firms, and/or other entities.

The fund management system may also allow a user to identify one or more mentors. The fund management system may allow a user to share all of the documents and/or information related to funds with which the user is associated with a mentor. The fund management system may allow a mentor to provide ratings, feedback, and/or other information related to a user, a document, a set of documents, documents of particular document type, a fund, and/or other entity related to the user. The fund management system may aggregate the ratings, feedback, and/or other information provided by the one or more mentors.

The fund management system may also enable the determination of investment themes based on investment research activity performed via the fund management system.

In some implementations, the fund management system may comprise, for example, fund management server, a non-transitory electronic storage device that may be communicably coupled to the fund management server, one or more client devices, a network via which the fund management server, storage device, and client devices may communicate, and/or other computing devices of the system.

The fund management server may include a physical processor configured to execute computer readable instructions to implement one or more system components. In some implementations, the server may comprise a non-transitory, tangible computer-readable storage medium with an executable program stored thereon, wherein the program instructs a microprocessor to perform some or all of the functionality of the plurality of system components. The system components may include, for example, a fund management component, a document sharing component, a role-based permissions component, a theme determination component, and/or other components. The fund management component may be configured to manage an investment fund, including, for example, facilitating creation of an investment fund and managing investment research conducted by users related to the investment fund. The document sharing component may be configured to facilitate sharing of a document for an investment fund with other users of the fund management system. The role-based permissions component may be configured to tailor access to the system, to a fund, to documents in the fund, and/or other access to the system based on one or more roles associated with a user of the system. The theme determination component may be configured to determine an investment theme for a potential investment fund based on activity of the fund management system.

In some implementations, the fund management component may comprise, for example, a fund creation component, a document uploading component, a performance updating component, a document subscription component, and/or other system components. The fund creation component may be configured to facilitate creation of a fund in the system, allow a user to provide fund permissions for the fund, and/or otherwise perform functionality related to creating an investment fund. The document uploading component may be configured to allow a user to upload a document for an investment fund, provide author permissions for the document, and/or otherwise manage the document. The performance updating component may be configured to receive information related to performance of an investment fund, update performance statistics, outlooks, and/or other logistics related to performance of the investment fund, and/or otherwise manage information related to the performance of an investment fund. The document subscription component may be configured to receive documents from third parties based on a third-party subscription, maintain subscriptions to third party information, allow a user to provide commentary on a document received from a third party, and/or otherwise manage subscriptions to third party information sources.

In some implementations, the document sharing component may comprise, for example, a relationship building component, a document access component, a third party ratings component, a mentor ratings component, and/or other system components. The relationship building component may be configured to allow a user to invite another entity to share information via the fund management system. The document access component may be configured to allow a third party to access a document of a user based on the set of fund permissions associated with the fund, based on author permissions associated with the document, and/or based on other information related to the document. The third party ratings component may be configured to allow an entity that shares information from a user to rate documents shared by the user, rate the user, rate a fund associated with the user, and/or otherwise provide ratings related to the user, aggregate ratings related to shared documents, aggregate ratings related to users, aggregate ratings related to funds, and/or otherwise manage ratings. The mentor ratings component may be configured to allow a user to identify mentors for the user, share documents with an identified mentor, receive a rating for an individual shared document from an identified mentor, receive feedback related to the individual shared document from the identified mentor, aggregate ratings from identified mentors for a user, and/or otherwise receive and manage feedback from one or more mentors.

These and other aspects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a block diagram of an exemplary system for sharing diligence information for an investment fund, according to various implementations of the invention.

FIG. 2 illustrates a block diagram of an exemplary document management system component, according to various implementations of the invention.

FIG. 3 illustrates a block diagram of an exemplary document sharing system component, according to various implementations of the invention.

FIG. 4 illustrates an exemplary process of managing permissions for a fund, according to various implementations of the invention.

FIG. 5 illustrates an exemplary screen shot of administration permissions settings for sharing fund information via a fund management portal, according to various implementations of the invention.

FIG. 6 illustrates a process for sharing fund information, according to various implementations of the invention.

FIG. 7 illustrates an exemplary screen shot of permissions settings for sharing fund information via a fund management portal, according to various implementations of the invention.

FIG. 8 illustrates an exemplary screen shot of third party information shared with a via a fund management portal, according to various implementations of the invention.

FIG. 9 illustrates a process for sharing a diligence document with a third party, according to various implementations of the invention.

FIGS. 10A and 10B illustrate an exemplary document shared with third parties, according to various implementations of the invention.

FIG. 11 illustrates a process for receiving and managing ratings for documents via a fund management portal, according to various implementations of the invention.

FIG. 12 illustrates an exemplary screen shot of rankings via a fund management portal, according to various implementations of the invention.

FIG. 13 illustrates a process for receiving and managing feedback from mentors, according to various implementations of the invention.

### DETAILED DESCRIPTION

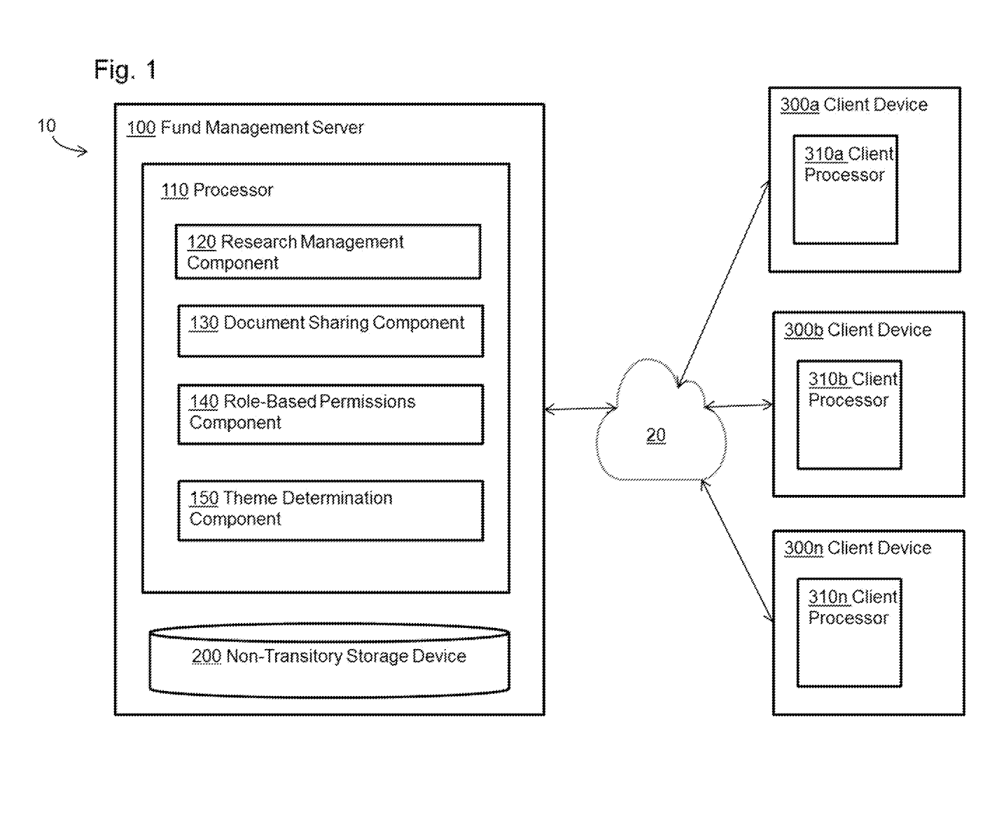

FIG. 1 illustrates an exemplary diagram of a fund management system 10 for sharing diligence information for an investment fund, according to an implementation of the invention. A plurality of investment firms may use the fund management system 10 to share diligence information related to investment funds managed by the individual firms. In one example, a first firm administrator of a first firm, a first set of managers of the first firm, a first set of analysts of the first firm, a first set of clients of the first firm, a first set of third parties that work with the first firm, and/or other users associated with the first firm may access the fund management system 10. A firm administrator of a second firm, a second set of managers of the second firm, a second set of analysts of the second firm, a second set of clients (which may or may not overlap with the first set of clients), a second set of third parties that work with the second firm (which may or may not overlap with the first set of third parties) may also use and access the fund management system 10.

The fund management system may facilitate management of the research performed to initiate and manage an investment fund. That research may include the creation, editing, sharing, and/or other management of numerous documents. The documents may be, for example, documents that comprise diligence information determined for an investment fund, notes about meetings, presentations, and/or other events related to an investment fund, performance reports and/or other reports related to the execution of the investment fund, and/or other documents involved in initiating, running, and/or otherwise managing an investment fund.

The system 10 may include a fund management server 100, a non-transitory electronic storage device 200 that may be communicably coupled to the fund management server 100, one or more client devices 300a, 300b, . . . , 300n, a network 20 via which the fund management server 100, storage device 200, and client devices 300a, 300b, . . . , 300n may communicate, and/or other computing devices of the system 10. An administrator of the fund management system, a firm administrator, manager, analyst, client, third party, and/or other user may access the fund management system via, for example, one or more interfaces (e.g., web pages) communicated from the fund management server 100 to a client device 300n, an application such as a mobile application executing on a client device 300n that generates the interface based on information communicated from the fund management server 100, an agent running on the fund management server 100, and/or via other interfaces.

The server 100 may include a physical processor 110 configured to execute computer readable instructions to implement one or more system components. In some implementations, the server 100 may comprise a non-transitory, tangible computer-readable storage medium with an executable program stored thereon, wherein the program instructs a microprocessor to perform some or all of the functionality of the plurality of system components. The system components may include, for example, a fund management component 120, a document sharing component 130, a role-based permissions component 140, a theme determination component 150, and/or other components. The fund management component 120 may be configured to manage an investment fund, including, for example, facilitating creation of an investment fund and managing investment research conducted by users related to the investment fund. The document sharing component 130 may be configured to facilitate sharing of a document for an investment fund with other users of the fund management system. The role-based permissions component 140 may be configured to tailor access to the system, to a fund, to documents in the fund, and/or other access to the system based on one or more roles associated with a user of the system. The theme determination component 150 may be configured to determine an investment theme for a potential investment fund based on activity of the fund management system.

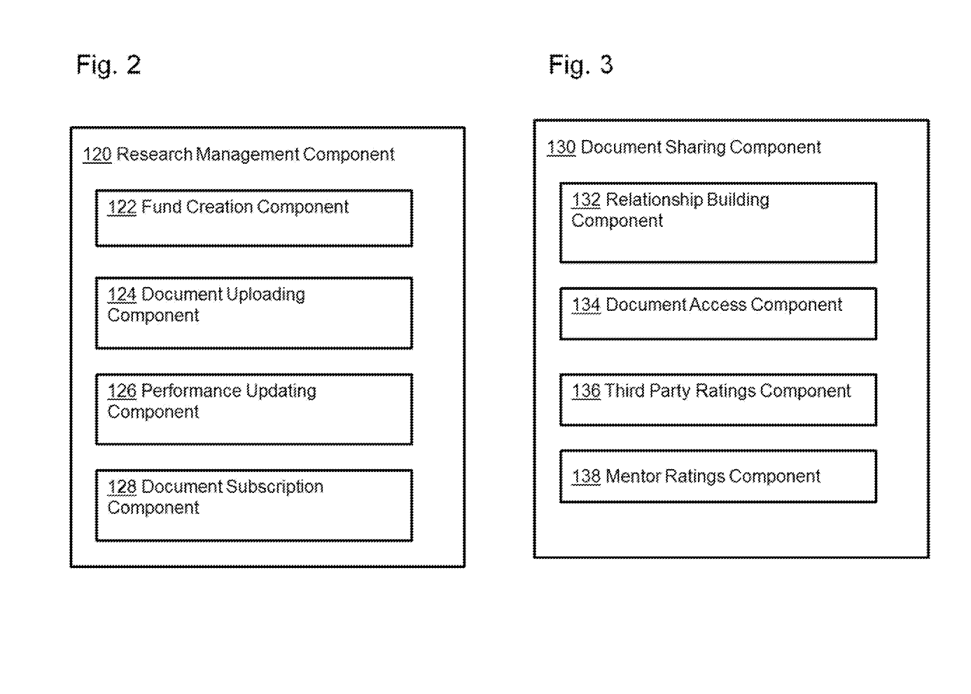

FIG. 2 illustrates a block diagram of an exemplary fund management system component 120, according to various implementations of the invention. The fund management component 120 may be configured to manage an investment fund, including, for example, facilitating creation of an investment fund, managing investment research conducted by users related to the investment fund, and/or otherwise managing the investment fund. For example, the fund management component 120 may enable a user to upload diligence documents, subscribe to documents from third parties, enter performance information related to an investment fund, and/or otherwise manage investment research information related to an investment fund.

In some implementations, the fund management component 120 may comprise, for example, a fund creation component 122, a document uploading component 124, a performance updating component 126, a document subscription component, 128, and/or other system components. The fund creation component 122 may be configured to facilitate creation of a fund in the system, allow a user to provide fund permissions for the fund, and/or otherwise perform functionality related to creating an investment fund. The document uploading component 124 may be configured to allow a user to upload a document for an investment fund, provide author permissions for the document, and/or otherwise manage the document. The performance updating component 126 may be configured to receive information related to performance of an investment fund, update performance statistics, outlooks, and/or other logistics related to performance of the investment fund, and/or otherwise manage information related to the performance of an investment fund. The document subscription component 128 may be configured to receive documents from third parties based on a third-party subscription, maintain subscriptions to third party information, allow a user to provide commentary on a document received from a third party, and/or otherwise manage subscriptions to third party information sources.

The fund creation component 122 may be configured to facilitate creation of a fund in the system, allow a user to provide fund permissions for the fund, and/or otherwise perform functionality related to creating an investment fund. The fund creation component 122 may allow a user to create a fund. For example, the fund creation component 122 may receive information related to a name of the fund, information related to one or more users of the fund management system as managers associated with the fund, information related to one or more users of the fund management system 10 as analysts associated with the fund, information related to one or more clients of the fund, information related to one or more allocators of the fund, documents related to the fund, and/or other information related to the fund. A document related to the fund may comprise, for example, a document related to a strategy of the fund, a document related to investment research and/or diligence information for the fund, a document related to persons involved with the fund, a document related to an event (e.g., presentation, meeting, and/or other event) associated with the fund, a document related to expected and/or actual performance of the fund, and/or other document related to the fund. For each document related to the fund, the fund creation component 122 may receive, from a user of the fund management system 10 as an author of the document, the document, a document type of the document, and/or other information related to the document.

The fund creation component 122 may receive, from a manager of the fund, a firm administrator associated with the fund, and/or an administrator of the fund management system, a set of fund permissions associated with the fund. The fund permissions may comprise a plurality of fund permission settings including, for example, a fund indicator, a set of document type indicators, a set of document rules, and/or other permissions related to access of the fund. In some implementations, a set of default fund permissions may be associated with a fund upon creation. The fund creation component 122 may allow a manager of the fund to revise the set of default permissions for the fund. In some implementations, the fund creation component 122 may allow the manager of the fund to create new permissions for the set of fund permissions.

The fund indicator may comprise an indication of whether any information related to the fund may be shared with entities outside of the managers, analysts, and/or other users identified with the fund. In some implementations, the fund indicator may also comprise a user list including a list of entities outside of the managers, analysts, and/or other users identified with the fund with whom information related to the fund may be shared. In some implementations, the user list may include a list of user roles, such that information may be shared with entities outside of the managers, analysts, and/or other users identified with the fund based on the user role of an individual entity.

An individual document type indicator of the set of document type indicators may comprise an indication of whether a document of a corresponding document type may be shared with entities outside of the managers, analysts, and/or other users identified with the fund. In some implementations, an individual document type indicator may also comprise a corresponding user list including a list of entities (and/or user roles) outside of the managers, analysts, and/or other users identified with the fund with whom information related to the fund may be shared. In some implementations, the set of document type indicators may comprise an individual document type indicator for each document type recognized by the fund management system. In some implementations, the set of document type indicators may comprise an individual document type indicator only for each document type that may be shared. In these implementations, based on the set of document type indicators not including an individual document type indicator corresponding to a particular document type, documents of that particular document type may not be shared.

An individual document rule of the set of document rules may comprise an indication of whether a particular document may be shared with entities outside of the managers, analysts, and/or other users identified with the fund. In some implementations, an individual document rule may also comprise a corresponding user list including a list of entities (and/or user roles) outside of the managers, analysts, and/or other users identified with the fund with whom information related to the fund may be shared. In some implementations, the set of document rules may comprise an individual document rule for each document for the fund. In some implementations, the set of document rules may comprise an individual document rule only for each document that may be shared. In these implementations, based on the set of document rules not including an individual document rule corresponding to a particular document, that particular document may not be shared.

In some implementations, a document rule may also comprise a set of portion rules. An individual portion rule of the set of portion rules may comprise an indication of whether a particular portion of the document may be shared with entities outside of the managers, analysts, and/or other users identified with the fund. In some implementations, an individual portion rule may also comprise a corresponding user list including a list of entities (and/or user roles) outside of the managers, analysts, and/or other users identified with the fund with whom information related to the fund may be shared. In some implementations, the set of portions rules may comprise a portion document rule for each portion of a document. In some implementations, the set of portion rules may comprise an individual portion rule only for each portion of the document that may be shared. In these implementations, based on the set of portion rules not including an individual portion rule corresponding to a particular document, that particular portion of the document may not be shared. The portions may be delineated based on the document type of the document, may be delineated based on input from the author of the document, and/or may be otherwise delineated.

The document uploading component 124 may be configured to allow a user to upload a document for an investment fund, provide author permissions for the document, and/or otherwise manage the document. The document uploading component 124 may receive, a user as an author of the document, a document for a fund, information related to the fund with which the document is associated, a document type of the document, author permissions for the document, a version label indicating whether the document is a draft or a final version, and/or other information related to the document.

The author permissions for a document may comprise a plurality of author permission settings including, for example, a document indicator, a set of portion rules, and/or other permissions related to access of the fund. In some implementations, a set of default author permissions may be associated with a document. The document creation component 124 may allow an author of the document to revise the set of default permissions for the document. In some implementations, the document creation component 124 may allow the author of the document to create new permissions for the set of author permissions.

A document indicator for a particular document may comprise an indication of whether the particular document may be shared with entities outside of the managers, analysts, and/or other users identified with the fund. In some implementations, a document indicator may also comprise a corresponding user list including a list of entities (and/or user roles) outside of the managers, analysts, and/or other users identified with the fund associated with the document with whom information related to the document may be shared.

An individual portion rule of the set of portion rules may comprise an indication of whether a particular portion of the document may be shared with entities outside of the managers, analysts, and/or other users identified with the fund. In some implementations, an individual portion rule may also comprise a corresponding user list including a list of entities (and/or user roles) outside of the managers, analysts, and/or other users identified with the fund with whom information related to the document may be shared. In some implementations, the set of portions rules may comprise a portion document rule for each portion of a document. In some implementations, the set of portion rules may comprise an individual portion rule only for each portion of the document that may be shared. In these implementations, based on the set of portion rules not including an individual portion rule corresponding to a particular document, that particular portion of the document may not be shared. The portions may be delineated based on the document type of the document, may be delineated based on input from the author of the document, and/or may be otherwise delineated.

In some implementations, the author rule may also comprise a version rule indicating whether a document labeled as a draft version (instead of a final version) may be shared with entities outside of the managers, analysts, and/or other users identified with the fund. In some implementations, an individual portion rule may also comprise a corresponding user list including a list of entities (and/or user roles) outside of the managers, analysts, and/or other users identified with the fund with whom information related to the draft version of the document may be shared. In some implementations, based on the author permissions not comprising a version rule, draft versions of a document may not be shared.

The performance updating component 126 may be configured to receive information related to performance of an investment fund, update performance statistics, outlooks, and/or other logistics related to performance of the investment fund, and/or otherwise update information related to the performance of an investment fund. The performance updating component 126 may receive information related to the performance of the fund from a user of the system (e.g., a manager, analyst, and/or other user involved in managing the fund), may obtain updated performance information by crawling the internet for information related to performance of the fund, may determine performance information based on documents received from a user, via subscription, and/or otherwise received, and/or may otherwise obtain information related to performance of a fund.

The performance updating component 126 may store a set of statistics and/or other performance information related to the fund in the non-transitory electronic storage device 300. The performance updating component 126 may update the set of statistics and/or other performance information responsive to obtaining performance information for a fund. For example, the performance updating component 126 may prepare a document comprising performance information for the fund. Based on the performance information, the fund management component 120 may provide a suggestion for activity to cause a change in performance of the fund to a manager, analyst, and/or other user involved in managing the fund.

The document subscription component 128 may be configured to receive documents from third parties based on a third-party subscription, maintain subscriptions to third party information, allow a user to provide commentary on a document received from a third party, and/or otherwise manage subscriptions to third party information sources. The document subscription component 128 may store documents received based on a third-party subscription for a fund in the non-transitory electronic storage device 300. The documents may have a document type associated with subscription. The document subscription component 128 may allow a user to provide commentary for a document obtained via a subscription. The document subscription component 128 may store the commentary provided by a user for a subscription document in the non-transitory electronic storage device 300. The commentary may comprise a document type associated with commentary.

The fund management component 120 may also provide reminders to analysts, managers and/or other users related to a fund regarding activities to perform, prompt analysts, managers, and/or other users for information related to the fund (e.g., based on activities and/or timelines associated with the fund), and/or provide other functionality related to managing a fund that may be provided by a fund management system. The fund management component 120 may also provide version control for documents, editing of documents, deletion of documents, and/or other functionality related to a document that may be provided by a document management system.

FIG. 3 illustrates a block diagram of an exemplary document sharing component 130, according to various implementations of the invention. The document sharing component 130 may be configured to facilitate sharing of a document for an investment fund with other users of the fund management system. The document sharing component 130 may be configured to facilitate sharing fund information between a user and third parties selected by the user, allow the selected third parties to provide ratings of users, documents, funds, and/or other entities via the fund management system, allow a user to select mentors and receive feedback from the selected mentors, and/or otherwise manage information related to a fund via the fund management system.

In some implementations, the document sharing component 130 may comprise, for example, a relationship building component 132, a document access component 134, a third party ratings component 136, a mentor ratings component 138, and/or other system components. The relationship building component 132 may be configured to allow a user to invite another entity to share information via the fund management system. The document access component 134 may be configured to allow a third party to access a document of a user based on the set of fund permissions associated with the fund, based on author permissions associated with the document, and/or based on other information related to the document. The third party ratings component 136 may be configured to allow an entity that shares information from a user to rate documents shared by the user, rate the user, rate a fund associated with the user, and/or otherwise provide ratings related to the user, aggregate ratings related to shared documents, aggregate ratings related to users, aggregate ratings related to funds, and/or otherwise manage ratings. The mentor ratings component 138 may be configured to allow a user to identify mentors for the user, share documents with an identified mentor, receive a rating for an individual shared document from an identified mentor, receive feedback related to the individual shared document from the identified mentor, aggregate ratings from identified mentors for a user, and/or otherwise receive and manage feedback from one or more mentors.

The relationship building component 132 may be configured to allow a user to invite another entity to share information via the fund management system. In some implementations, the relationship building component 132 may be configured to allow the user to invite a third party to share information based on the fund permissions associated with a fund related to the user. For example, the relationship building component 132 may be configured to allow the user to invite the third party responsive to the other entity having a user role and/or user identification included in the user list of the set of fund permissions for the fund. In some implementations, the user may be associated with a plurality of funds. In these implementations, the relationship building component 132 may be configured to allow the user to invite the third party to share information responsive to the third party having a user role and/or user identification included in a user list of a set of fund permissions of at least one fund associated with the user. In some implementations, the relationship building component 132 may be configured so as to not restrict the entities that may be invited by the user.

The relationship building component 132 may be configured to receive a request from a user to share information with a third party. For example, the relationship building component 132 may be configured to receive a request from a manager, analyst, and/or other user to share information with a third party. In some examples, the user may be associated with a fund and the third party may be another entity not associated with the fund.

Responsive to receiving the request to share information with the third party, the relationship building component 132 may be configured to prompt the third party to respond to the request. For example, the relationship building component 132 may send the third party an email, may provide a checkbox, link, and/or other input mechanism, and/or may otherwise prompt the third party to respond to the request.

Responsive to the third party accepting the request to share information, the set of fund permissions for each fund associated with the user may be updated to include the third party in the user list for the set of fund permissions. In some implementations, the user may select specific funds for which the user list may be updated to include the third party. In some implementations, the user may select specific fund permission settings for a particular fund for which the user list may be updated to include the third party. Based on the third party accepting the request and the set of fund permissions for each individual fund associated with the user being updated, the relationship building component 132 may be configured to share information related to the individual funds associated with the user with the third party based on the respective individual set of fund permissions for each individual fund. For example, the relationship building component 132 may provide the third party with access to information related to an individual fund and one or more documents associated with that fund based on the individual fund being shared with the third party.

Responsive to the third party accepting the request, the set of fund permissions for each fund associated with the third party may also be updated to include the user in the user list for the set of fund permissions. In some implementations, the third party may select specific funds for which the user list may be updated to include the user. In some implementations, the third party may select specific fund permission settings for a particular fund for which the user list may be updated to include the user. Based on the third party accepting the request and the set of fund permissions for each individual fund associated with the third party being updated, the relationship building component 132 may be configured to share information related to the individual funds associated with the third party with the user based on the respective individual set of fund permissions for each individual fund. For example, the relationship building component 132 may provide the user with access to information related to an individual fund and one or more documents associated with that fund based on the individual fund being shared with the user.

The document access component 134 may allow a third party to request access to a document for a fund that has been shared by the user. As mentioned above, the relationship building component 132 may be configured to provide access to information related to the document. For example, the relationship building component 132 may output to the third party information related to the document, including, for example, a name of the document, a fund associated with the document, a document type of the document, and/or other information related to the document. Along with the document, the relationship building component may also output a link, button, checkbox, and/or other input mechanism via which the user may request the document.

The document access component 134 may allow a third party to receive a document of a user based on the set of fund permissions associated with the fund, based on author permissions associated with the document, and/or based on other information related to the document. For example, the document access component 134 may determine whether the third party was included in the set of fund permissions for the fund and/or the set of author permissions for the fund. Responsive to the third party being included in the set of fund permissions for the fund and/or the set of author permission for the fund, the document access component 134 may determine whether the third party was included in the fund permissions and author permissions associated with the particular document. Responsive to the third party having permission to access the document based on the set of fund permissions for the document and the set of author permissions for the document, the document access component 134 may output the document to the third party.

In some implementations, the document access component 134 may determine which portions of the document may be output to the third party based on the set of author permissions associated with the document. The document access component 134 may determine which portions of the document may be output to the third party based on the set of fund permissions for the document and the set of author permissions for the document. For example, the document access component 134 may determine which portions of the document may be shared with the third party based on the document rules of the set of fund permissions and based on the document rules of the set of author permissions. The document access component 134 may output to the third party those portions for which both the set of fund permissions and the set of author permissions permit access. For example, for a document comprising a first portion, a second portion, and a third portion, the first portion and the third portion of the document may be output to the user, while the second portion may be omitted based on the set of author permissions for the document. In some examples, the document may comprise a notation that the second portion was omitted and/or other information related to the omitted second portion. In some examples, the document may not comprise any information related to the omitted second portion.

In some implementations, the document access component 134 may determine that the set of author permissions associated with the document do not permit the document to be output to the third party. In these implementations, the document access component 134 may prevent display of a link, button, checkbox, and/or other input mechanism via which the user may request the document. In some examples, the document access component 134 may output the information provided to the third party based on the set of fund permissions associated with the document (e.g., metadata including the name of the document, author of the document, name of associated fund, document type, and/or other metadata) without outputting the contents of the document.

The third party ratings component 136 may be configured to allow an entity that shares information from a user to rate documents shared by the user, rate the user, rate a fund associated with the user, aggregate ratings related to shared documents, aggregate ratings related to users, aggregate ratings related to funds, and/or otherwise manage ratings.

In some implementations, the third party ratings component 136 may be configured to restrict a user from rating a document, fund, user, and/or other entity with which the user is not associated. For example, the third party ratings component 136 may be configured to allow a user to rate only those users with whom the user is sharing information. In another example, the third party ratings component 136 may be configured to allow a user to rate only those funds and/or documents to which the user has access. In some implementations, the third party ratings component 136 may be configured to allow a user to rate any other user, document, fund, and/or other entity without restriction.

The third party ratings component 136 may be configured to allow rating by a user at various levels in a fund. For example, the third party ratings component 136 may be configured to allow a user to rate a fund, rate one or more users associated with the fund, and/or otherwise rate information related to the fund as a whole. The third party ratings component 136 may be configured to allow a user to rate a document of a fund, rate one or more users associated with the document, rate one or more portions of the document, any combination thereof, and/or otherwise rating information relating to a document. In some implementations, the third party ratings component 136 may be configured to allow ratings of a fund, ratings of documents in a fund, ratings of documents of a fund that all share a same document type, ratings of users with a same user role associated with a fund, any combination thereof, and/or other ratings of a fund. In some implementations, the third party ratings component 136 may be configured to allow a user to provide a first rating and then provide a second rating that replaces the first rating.

The third party ratings component 136 may allow a user to provide a binary rating (e.g., a like, thumbs up, and/or other binary rating), a scaled rating, any combination thereof, and/or other type of rating. For example, the third party ratings component 136 may be configured to allow a user to “like” a document as well as provide a rating on a scale of 1 to 10 regarding the document. In some implementations, the third party ratings component 136 may provide scaled ratings for one or more attributes associated with an entity. For example, the non-transitory storage device 200 may be configured to store a set of attributes for a fund, a set of attributes for a document, a set of attributes for a user, and/or other sets of attributes for other entities. In some implementations, for a user, the non-transitory electronic storage device 200 may be configured to store a distinct set of attributes for each user role. The third party ratings component 136 may be configured to provide scaled ratings for each attribute associated with an entity based on the type of entity. In some implementations, the third party ratings component 136 may be configured to provide information related to the set of attributes associated with an entity and allow a user to select those attribute which the user wants to rate. The third party ratings component 136 may store any ratings received from users in the non-transitory electronic storage device 200.

In some implementations the scale used for a scaled rating may be uniform throughout the fund management system, such that every document, fund, user, and/or other entity of the system may be rated on a same scale. In some implementations, a same scale may be used for each type of entity. For example, users may be rated on a first scale, documents may be rated on a second scale, funds may be rated on a third scale, and/or other entities may be rated on a distinct scale. In another example, different attributes associated with an entity may be rated on a same scale or a different scale. The scale(s) used for ratings may be determined by an administrator of the fund management system, may be pre-set before use of the fund management system, and/or may be otherwise determined.

In some implementations, the third party ratings component 136 may be configured to allow a user to provide feedback regarding any fund, document, user, and/or other entity for which the user may be allowed to provide a rating. The feedback may be provided via text, via attachment of a document, via selection of descriptors for association with the entity for which feedback is provided, by text message, by voicemail and/or other types of oral communication, and/or by other ways of providing feedback. The third party ratings component 136 may be configured to allow a user to provide feedback and/or ratings for an entity for which the user is allowed to provide a rating.

In some implementations, the third party ratings component 136 may be configured to aggregate ratings received via the fund management system. The third party ratings component 136 may be configured to aggregate ratings for a fund, for a document, for documents of a particular document type, for a user, and/or other types of ratings.

In some implementations, the third party ratings component 136 may be configured to provide aggregated ratings of entities associated with a fund. For example, for a particular fund, the third party ratings component 136 may be configured to provide information related to aggregated ratings for the fund, aggregated ratings for one or more users associated with the fund, aggregated ratings of one or more users associated with the fund that share a same user role, aggregated ratings of one or more documents of the fund, aggregated ratings of one or more documents of the fund of a same document type, and/or other aggregated ratings related to the fund. The third party ratings component 136 may be configured to output information related to one or more aggregated ratings for a fund to a user based on the user role of the user in association with the fund. For example, the third party ratings component 136 may be configured to provide all of the aggregated ratings for the fund to a user with a user role of an administrator, a firm administrator, a manager, and/or other user role with the fund, and may be configured to provide a subset of the aggregated ratings for the fund to a user of another user role.

In some implementations, the third party ratings component 136 may be configured to provide aggregated ratings of entities associated with a user. For example, for a particular user, the third party ratings component 136 may be configured to provide information related to aggregated ratings for the user, aggregated ratings for one or more funds associated with the fund, aggregated ratings of one or more documents associated with a user, aggregated ratings of one or more documents of a fund associated with a user, aggregated ratings of one or more documents associated with the user of a same document type, aggregated ratings of funds and/or documents based on same user role of the user as associated with the respective fund and/or document, and/or other aggregated ratings related to the fund. The third party ratings component 136 may be configured to output information related to one or more aggregated ratings for a user to the user. In some implementations, the third party ratings component 136 may be configured to provide aggregated ratings for the user to other users associated with the user (e.g., another user associated with a fund with which the user is associated, a user with user role of manager for a fund associated with the user, a firm administrator associated with the fund, an administrator of the fund management, system, and/or other users).

The third party ratings component 136 may be configured to aggregated ratings for an entity by combining received ratings for that entity. In some implementations, the third party ratings component 136 may be configured to weight ratings for aggregation. Weights may be provided based on a number of users that provide ratings for a particular entity, number of requests for documents related to the entity, user role of user providing the rating, number of ratings made by user providing the rating, number of funds associated with the user providing the rating, aggregated rating of the user providing the rating, recency of the rating, any combination thereof, and/or other types of weights. In some implementations, a firm administrator associated with the fund, an administrator of the fund management system, and/or other user may determine which weights to user for aggregating ratings for each entity.

In some implementations, the third party ratings component 136 may be configured to rank funds, documents, users, and/or other entities based on associated aggregated ratings. For example, the third party ratings component 136 may be configured to output ratings for a top predetermined number of funds, users, documents, and/or other entities to all users in the fund management system. In another example, the third party ratings component 136 may be configured to provide ratings based on user role of the user requesting ratings.

The mentor ratings component 138 may be configured to allow a user to identify one or more mentors for the user, share documents with an identified mentor, receive a rating for an individual shared document from an identified mentor, receive feedback related to the individual shared document from the identified mentor, aggregate ratings from identified mentors for a user, and/or otherwise receive and manage feedback from one or more mentors for a user.

The mentor ratings component 138 may be configured to allow a user to select one or more mentors. In some implementations, the mentor ratings component 138 may provide a predetermined list of users from which the user may select one or more mentors. The predetermined list of users may comprise, for example, a user with a user role of manager for a fund with which the user is associated, any user associated with a fund with which the user is associated, a user that serves as a mentor for another user, and/or any other type of user. In some examples, the mentor ratings component 138 may receive indications from users that are willing to act as mentors to be included in the predetermined list. In another example, the mentor ratings component 138 may be configured to allow a user to select any other user in the fund management system as a mentor. The mentor ratings component 138 may be configured to save information related to the one or more selected mentors in association with the user in the non-transitory electronic storage device 200.

The mentor ratings component 138 may be configured to allow a mentor to provide ratings, feedback, and/or other information to the user. The ratings, feedback, and/or other information may be related to the user, related to a fund associated with the user, related to a document associated with the user, related to a portion of a document associated with the user, and/or otherwise related to the user.

The mentor ratings component 138 may receive and/or manage ratings, feedback, and/or other information from mentors in a manner similar to the third party ratings component 138. In some implementations, the mentor ratings component 138 may provide information received from one or more mentors only to the user for which the information is provided. In some implementations, the mentor ratings component 138 may provide information received from one or more mentors to the user, and one or more mentors, other users selected by the user, all users of the system, any combination thereof, and/or other types of users.

Returning to FIG. 1, the role-based permissions component 140 may be configured to tailor access to the system, to a fund, to documents in the fund, and/or other access to the system based on one or more roles associated with a user of the system.

The role-based permission component 140 may be configured to tailor access to the system based on roles of various users including, for example, a role in the system, a role in a fund, and/or other roles. The one or more roles may include system-level roles, fund-level roles, and/or other types of roles. System-level roles may grant access to various system features such as for example, access to one or more components, access to content stored at a storage component, and/or other access to system features. System-level roles may be configured, for example, to manage storage of information in the non-transitory electronic storage device 200, access to funds, access to documents, access to ratings, access to feedback, access to scales for ratings, access to attributes for entities, and/or other system-level features. Different system-level roles may be granted that provide access to different system features. Fun-level roles may grant access to various features related to funds such as, for example, access to the content of the fund, access to information of users of the fund, access to ratings and/or feedback related to the fund, and/or other access. Different fund-based roles may be granted that provide access to different fund features. The role-based permissions component 180 may maintain a plurality of roles, including, for example, administrator of the fund management system, firm administrator, manager, analyst, third party, and/or other roles.

The theme determination component 150 may be configured to determine an investment theme for a potential investment fund based on activity of the fund management system. For example, the theme determination component 150 may determine an investment theme for a potential investment in a manner the same or similar as that described in related co-pending U.S. Non-Provisional patent application Ser. No. ______, entitled “System and Method for Determining an Investment Theme,” filed on ______, 2013, which is hereby incorporated by reference in its entirety.

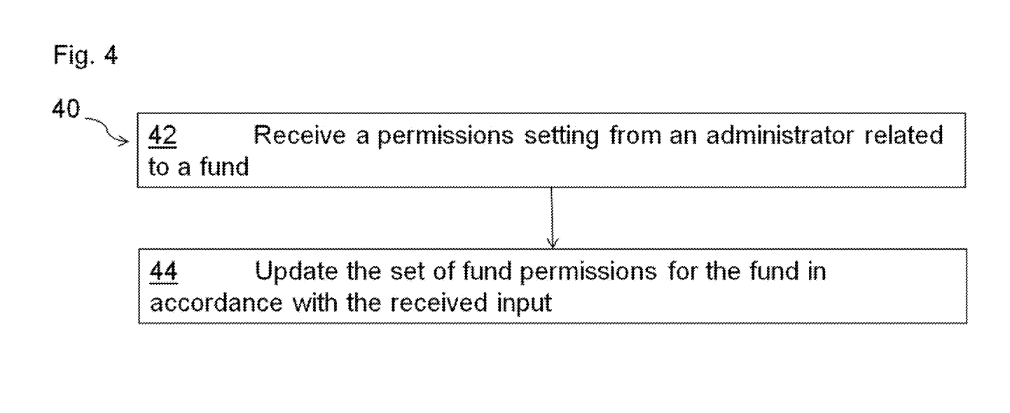

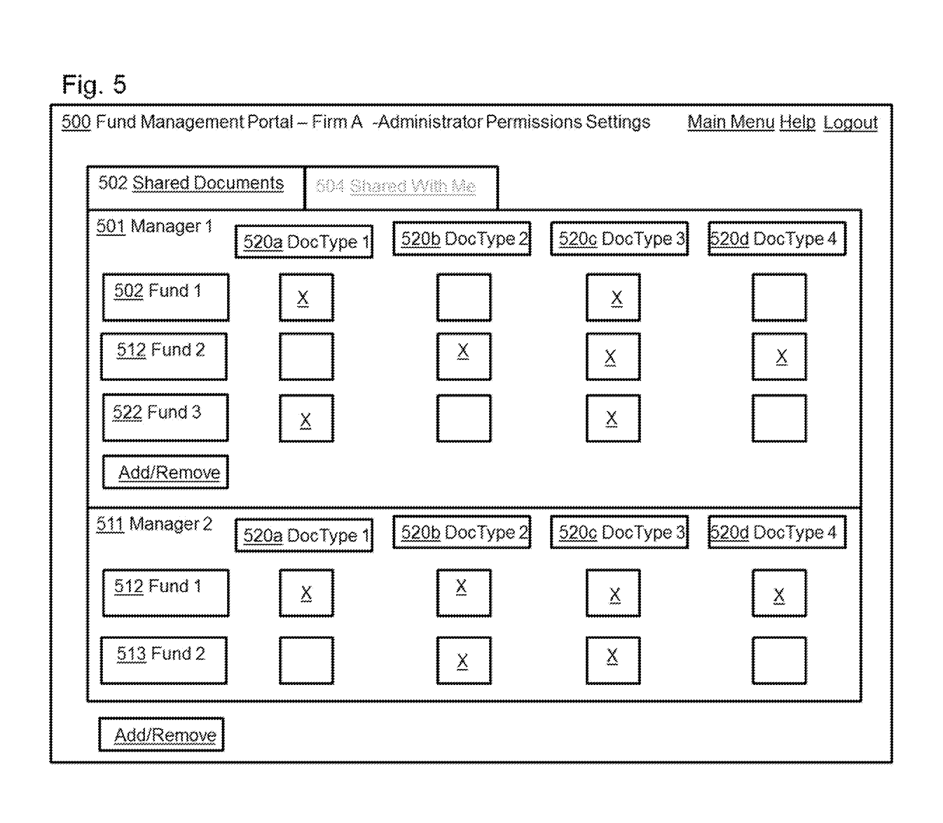

FIG. 4 illustrates an exemplary process of managing permissions for a fund, according to various implementations of the invention. FIG. 5 illustrates an exemplary screen shot of administration permissions settings for sharing fund information via a fund management portal, according to various implementations of the invention. Processing will be described with respect to FIG. 4 in reference to the screen shots illustrated in FIG. 5.

The described operations of FIG. 4 and other figures may be accomplished using some or all of the system components described in detail above and, in some implementations, various operations may be performed in different sequences. In other implementations, additional operations may be performed along with some or all of the operations shown in FIG. 4 and the other figures. In yet other implementations, one or more operations may be performed simultaneously. In yet other implementations, one or more combinations of various operations may be performed. Some implementations may not perform all of the operations described with relation to FIG. 4 and other figures. Accordingly, the operations described are exemplary in nature and, as such, should not be viewed as limiting.

In some embodiments, the operations described in FIG. 4 and the other figures may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations described in FIG. 4 and the other figures in response to instructions stored electronically on an electronic storage medium. The one or more processing devices may include one or more devices configured through hardware, firmware, and/or software to be specifically designed for execution of one or more of the operations described in FIG. 4 and the other figures.

The screenshots illustrated in FIG. 5 and other drawing figures are for illustrative purposes only. Various components may be added, deleted, moved, or otherwise changed so that the configuration, appearance, and/or content of the screenshots may be different than as illustrated in the figures. Accordingly, the graphical user interface objects as illustrated (and described in greater detail below) are exemplary by nature and, as such, should not be viewed as limiting. Interface 500 and other interfaces described herein may be implemented as a web page communicated from fund management server 100 to a user computing device (e.g., client device 300a, 300b, . . . , 300n), an application such as a mobile application executing on a client device, and/or other computing device that receives generates the interface based on information communicated from fund management server 100, and/or other interface. Whichever type of interface is used, fund management server 100 may communicate the data and/or formatting instructions related to the interface to the client, causing the client computing device, and/or other computing device to generate the various interfaces of FIG. 5 and other drawing figures. Furthermore, fund management server 100 may receive data from the client computing device, and/or other computing device via the various interfaces, as would be appreciated.

In an operation 42, a permissions setting related to a fund may be received from an administrator of the fund management system. The research management component 120 may receive the permissions setting from the administrator via a fund management portal user interface, by email, and/or by other methods of communication. The research management component 120 may receive the permissions setting for the fund in a manner the same or similar as that described above.

In an operation 44, the set of fund permissions for the fund may be updated in accordance with the received input. The research management component 120 may update the set of fund permissions for the fund based on the permissions setting received. The research management component 120 may update the set of fund permissions for the fund in a manner the same or similar as that described above.

FIG. 5 illustrates an exemplary screen shot of administration permissions settings for sharing fund information via a fund management portal user interface 500, according to various implementations of the invention. In some implementations, user interface 500 may be presented that includes an exemplary template for a firm administrator to provide permissions settings for funds related to one or more managers. The template for administrator permissions settings may be presented to a user with a firm administrator role upon initial access of the system, upon request for the template, and/or responsive to an action by the user. The user interface 500 may include, for example, shared documents portion 502, shared with me portion 504, a navigation bar portion, and/or other portions that display information.

The shared documents portion 502 may comprise, for example, one or more manager portions (e.g., manager 1 portion 501, manager 2 portion 502, and/or other manager portions). The manager portions displayed may comprise a set of managers of a firm, a set of managers previously identified and/or selected by the user, all of the managers associated with the same firm as the firm administrator that are using the fund management system, a predetermined number of the top ranked managers, a predetermined number of managers associated with the top ranked funds, a predetermined number of managers associated with the top ranked documents, and/or another set of managers. In some implementations, the user interface 500 may be presented to the user responsive to the user selecting to view administrator permissions. In some implementations, the user interface 500 may be presented to the user responsive to the user selecting to view administrator permissions and selecting the set of managers to display. The shared documents portion 502 may also comprise an add/remove input mechanism (e.g., a link, button, and/or other input) via which a user may add and/or remove a manager portion. The funds may be selectable links, buttons, and/or other interactive elements via which a user may be presented with further information about the selected fund.

A manager portion (e.g., manager portion 501) may display information related to a set of funds associated with the manager. For example, manager portion 501 may display information related to Fund 1 502, Fund 2 512, Fund 3 522, and/or other funds. The information may comprise, for example, a fund name, investment theme for the fund, and/or other information related to the fund. The fund information may be presented via a selectable link, button, and/or other interactive element via which a user may be presented with further information about the selected fund.

The manager portion 501 may also display information related to document types. For example, the manager portion 501 may display information related to DocType1 520a, DocType2 520b, DocType3 520c, DocType4 520d, and/or other document types. The information related to the document type may comprise, for example, a textual description of the document type. In some implementations, the information related to the document type may be presented via a selectable link, button, and/or other interactive element via which the user may be presented with information about documents that might have a same document type. In some implementations, information related to analysts, information related to whether a document comprises proprietary information, and/or other information may be displayed in lieu of and/or in addition to the information about document type. In some implementations, the other information may be presented via other user interfaces of the fund management system.

The manager portion 501 may also display checkboxes via which the firm administrator may select documents types for each fund displayed, such that, responsive to a document type being selected for a fund, all documents of that type may be shared. Responsive to other types of information being displayed, the manager portion 501 may display checkboxes associated with the other information in a manner the same as or similar to the display and functionality of the checkboxes related to document type. In some implementations, responsive to a checkbox being selected, the fund management system may present another user interface to the firm administrator via which the firm administrator may revise the user list associated with the set of permissions related to the fund. For example, the firm administrator may add and/or remove users with permission to access documents of the selected document type for the selected fund. In some implementations, the user interface via which the firm administrator may revise the set of permissions related to the fund may be presented via a popup window, may be superimposed on the user interface 500, and/or may be otherwise presented.

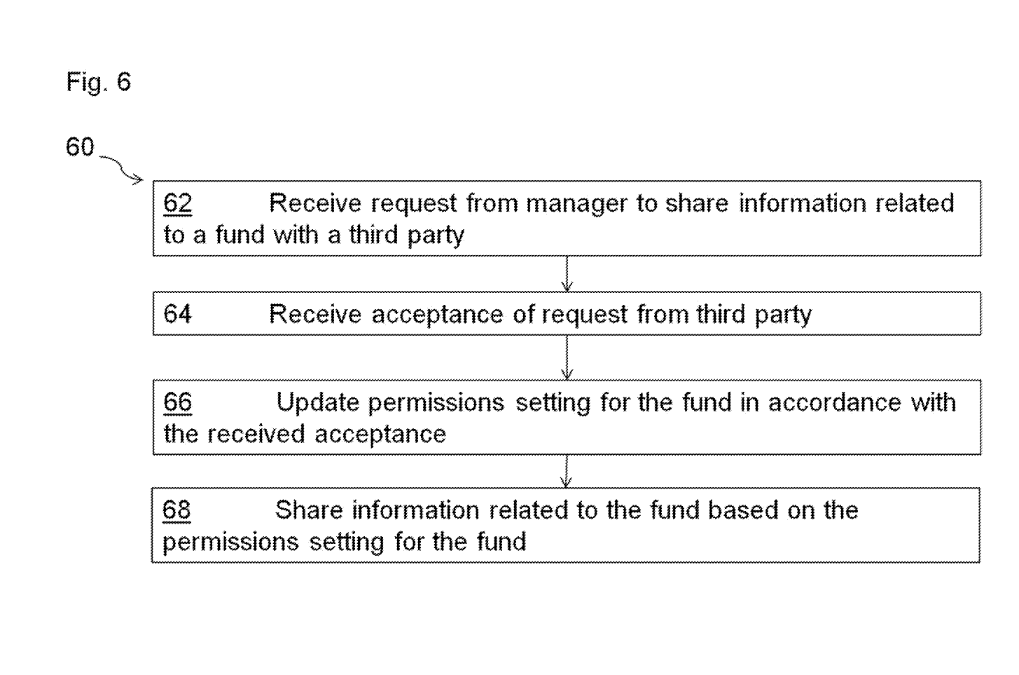

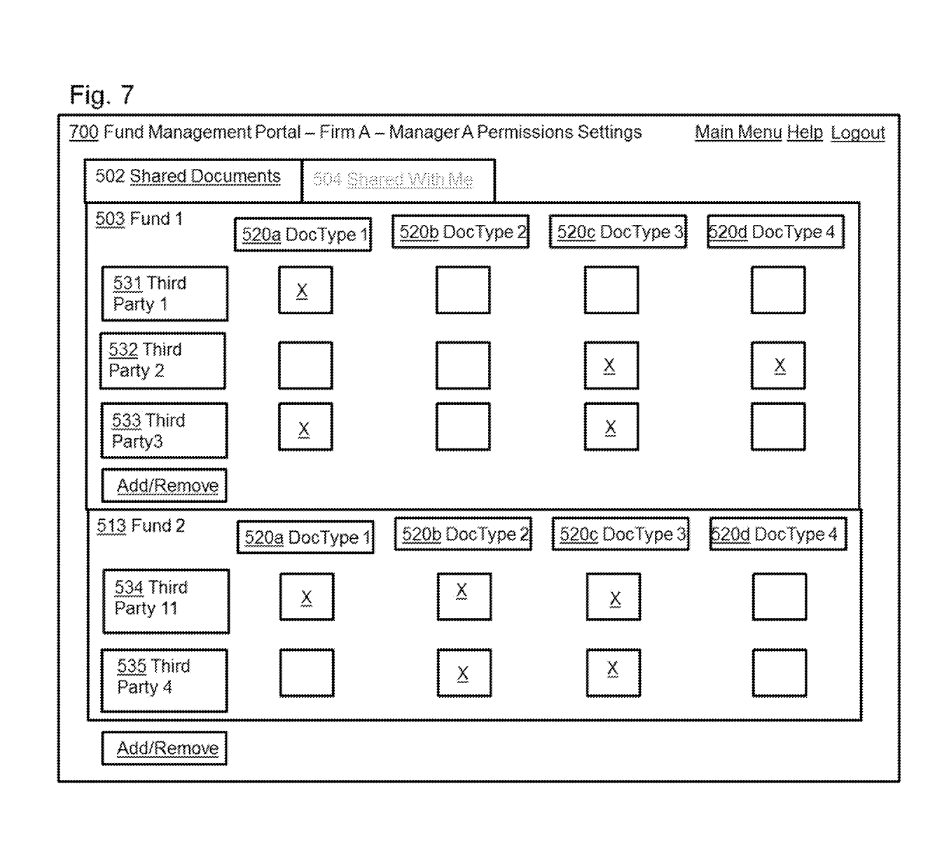

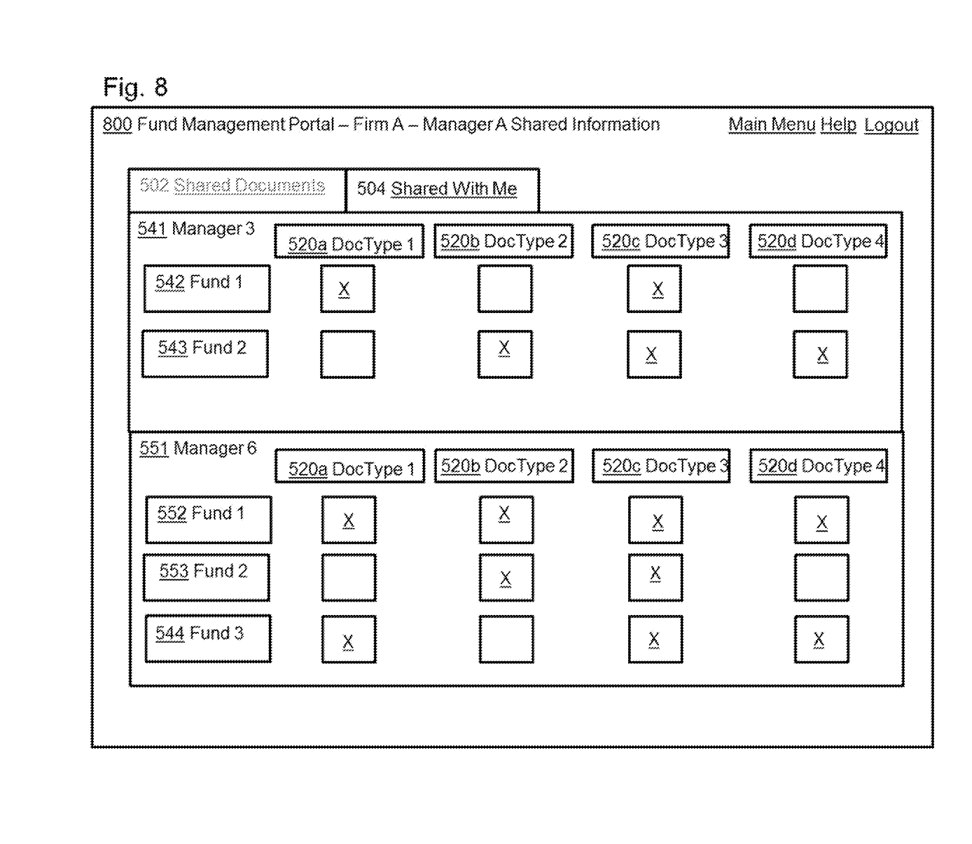

FIG. 6 illustrates a process for sharing fund information, according to various implementations of the invention. FIG. 7 illustrates an exemplary screen shot of permissions settings for a manager of a firm to share fund information via a fund management portal, according to various implementations of the invention. FIG. 8 illustrates an exemplary screen shot of third party information shared with a via a fund management portal, according to various implementations of the invention.

In an operation 62, a request from a manager to share information related to a fund with a third party may be received. The relationship building component 132 may receive the request from a manager to share information related to a fund with a third party via a fund management portal user interface, by email, and/or by other methods of communication. The relationship building component 132 may receive the request from a manager to share information related to a fund with a third party in a manner the same or similar as that described above.

In an operation 64, an acceptance of the request may be received by the third party. The relationship building component 132 may receive the acceptance via a fund management portal user interface, by email, and/or by other methods of communication. The relationship building component 132 may receive the acceptance in a manner the same or similar as that described above.

In an operation 66, permissions settings for the fund may be updated in accordance with the received acceptance. The relationship building component 132 may update the permissions settings for the fund. The relationship building component 132 may update the permissions settings for the fund in a manner the same or similar as that described above.

In an operation 68, information related to the fund may be shared with the third party based on the permissions setting for the fund. The relationship building component 132 and/or the document access component 134 may share information related to the fund with the third party based on the permissions settings for the fund. The relationship building component 132 and/or the document access component 134 may share information related to the fund with the third party based on the permissions settings for the fund in a manner the same or similar as that described above.

FIG. 7 illustrates an exemplary screen shot of permissions settings for a manager of a firm to share fund information via a fund management portal, according to various implementations of the invention. In some implementations, user interface 700 may be presented that includes an exemplary template for a manager to provide permissions settings for funds related to the manager. The template for fund permissions settings may be presented to a user with a manager role upon initial access of the system, upon request for the template, and/or responsive to an action by the user. The user interface 700 may include, for example, shared documents portion 502, shared with me portion 504, one or more fund portions 503, 513, . . . . , 5n3, a navigation bar portion, and/or other portions that display information.

The fund portions 503, 513, . . . , 5n3 may comprise, for example, one or more fund portions (e.g., fund portion 503, fund portion 513, and/or other fund portions). The fund portions displayed may comprise a set of funds associated with the user (in the role of manager of the firm), a set of funds previously identified and/or selected by the user, all of the funds associated with the firm of the manager, a predetermined number of the top ranked funds associated with the user, a predetermined number of funds associated with the top ranked documents, and/or another set of funds. In some implementations, the user interface 700 may be presented to the user responsive to the user selecting to view fund permissions. In some implementations, the user interface 700 may be presented to the user responsive to the user selecting to view fund permissions and selecting the set of fund to display. The fund portions 503, 513, . . . , 5n3 may also comprise an add/remove input mechanism (e.g., a link, button, and/or other input) via which a user may add and/or remove a fund portion. The funds may be selectable links, buttons, and/or other interactive elements via which a user may be presented with further information about the selected fund.

A fund portion (e.g., fund portion 503) may display information related to a particular fund, information related to third parties with whom fund information may be shared (e.g., third parties with whom fund information may be shared based on the set of fund permission associated with the funds), and/or other information related to the funds. For example, fund portion 503 may display information related to Third Party 1 531, Third Party 2 532, Third Party 3 533, and/or other third parties. Fund portion 513 may display information related to Third Party 11 534, Third Party 4 535, and/or other third parties. The information related to a third party may comprise, for example, an identification of the third party, identification of one or more individuals associated with the third party, and/or other information related to the third party. The third party information may be presented via a selectable link, button, and/or other interactive element via which a user may be presented with further information about the selected third party.

The fund portion 503 may also display information related to document types. For example, the manager portion 501 may display information related to DocType1 520a, DocType2 520b, DocType3 520c, DocType4 520d, and/or other document types. The information related to the document type may comprise, for example, a textual description of the document type. In some implementations, the information related to the document type may be presented via a selectable link, button, and/or other interactive element via which the user may be presented with information about documents that might have a same document type. In some implementations, information related to analysts, information related to whether a document comprises proprietary information, and/or other information may be displayed in lieu of and/or in addition to the information about document type. In some implementations, the other information may be presented via other user interfaces of the fund management system.

The fund portion 503 may also display checkboxes via which the firm administrator may select documents types for each third party displayed, such that, responsive to a document type being selected for a third party, all documents of that type from the fund may be shared with the selected third party. Responsive to other types of information being displayed, the fund portion 503 may display checkboxes associated with the other information in a manner the same as or similar to the display and functionality of the checkboxes related to document type. In some implementations, responsive to a checkbox being selected, the fund management system may present another user interface to the manager via which the manager may revise the user list associated with the set of permissions related to the fund. For example, the manager may add and/or remove third parties with permission to access documents of the selected document type for the selected fund. In some implementations, the user interface via which the manager may revise the set of permissions related to the fund may be presented via a popup window, may be superimposed on the user interface 700, and/or may be otherwise presented.

FIG. 8 illustrates an exemplary screen shot of third party information shared with a via a fund management portal, according to various implementations of the invention.

In some implementations, user interface 800 may be presented that includes an exemplary template for a manager to view information shared by other users via the fund management portal. The template for viewing shared information may be presented to a user with a firm administrator role upon initial access of the system, upon request for the template, and/or responsive to an action by the user. The user interface 800 may include, for example, shared documents portion 502, shared with me portion 504, a navigation bar portion, and/or other portions that display information.

The shared with me portion 504 may comprise, for example, one or more manager portions (e.g., manager 3 portion 541, manager 6 portion 551, and/or other manager portions). The manager portions displayed may comprise a set of managers with whom the user has shared information, a set of managers with whom the user has shared information that were previously identified and/or selected by the user, all of the managers with whom the user has shared information, a predetermined number of the top ranked managers with whom the user has shared information, a predetermined number of managers associated with the top ranked funds with whom the user has shared information, a predetermined number of managers associated with the top ranked documents with whom the user has shared information, and/or another set of managers with whom the user has shared information.

In some implementations, the user interface 800 may be presented to the user responsive to the user selecting to view shared information. In some implementations, the user interface 800 may be presented to the user responsive to the user selecting to view shared information and selecting the set of managers with whom the user has shared information to display. The shared documents portion 502 may also comprise an add/remove input mechanism (e.g., a link, button, and/or other input) via which a user may add and/or remove a manager portion. The funds, managers, and/or other information presented may be selectable links, buttons, and/or other interactive elements via which a user may be presented with further information about the selected fund, selected manager, and/or other selected information.

A manager portion (e.g., manager portion 541) may display information related to a set of funds associated with the manager 3. For example, manager portion 541 may display information related to Fund 1 542, Fund 2 543, and/or other funds. In another example, manager portion 551 may display information related to Fund 1 552, Fund 2 553, Fund 3 554, and/or other funds. The information may comprise, for example, a fund name, investment theme for the fund, and/or other information related to the fund. The fund information may be presented via a selectable link, button, and/or other interactive element via which a user may be presented with further information about the selected fund.

The manager portions 541, 551, and/or other manager portions may also display information related to document types. For example, the manager portion portions 541, 551, and/or other manager portions may display information related to DocType1 520a, DocType2 520b, DocType3 520c, DocType4 520d, and/or other document types. The information related to the document type may comprise, for example, a textual description of the document type. In some implementations, the information related to the document type may be presented via a selectable link, button, and/or other interactive element via which the user may be presented with information about documents that might have a same document type. In some implementations, information related to analysts, information related to whether a document comprises proprietary information, and/or other information may be displayed in lieu of and/or in addition to the information about document type. In some implementations, the other information may be presented via other user interfaces of the fund management system.

The manager portions 541, 551, and/or other manager portions may also display checkboxes that show the document types for each fund displayed, such that, responsive to a document type being selected for a fund, all documents of that type may be shared with the manager. Responsive to other types of information being displayed, the manager portions 541, 551, and/or other manager portions may display checkboxes associated with the other information in a manner the same as or similar to the display and functionality of the checkboxes related to document type.

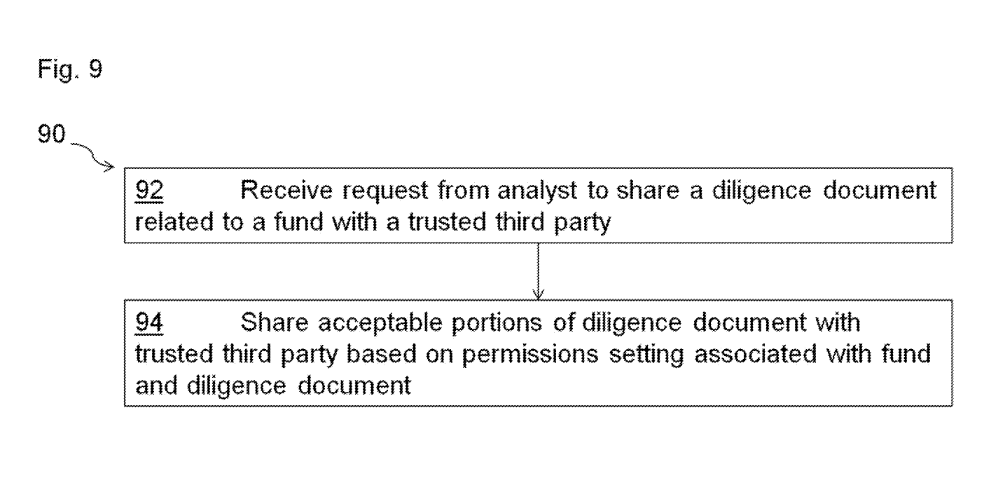

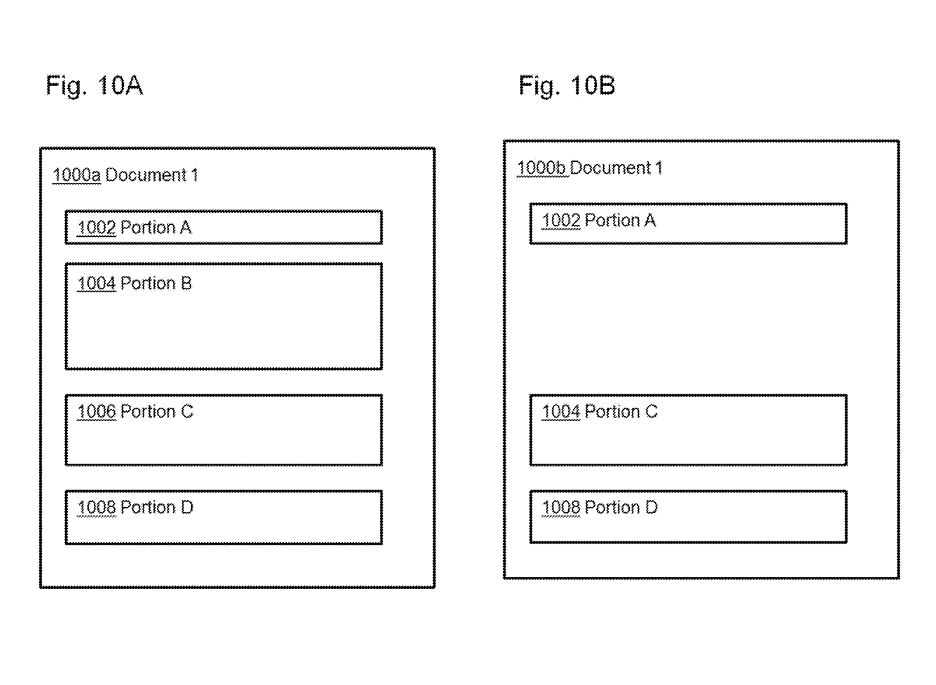

FIG. 9 illustrates a process for sharing a diligence document with a third party, according to various implementations of the invention. FIGS. 10A and 10B illustrate an exemplary document shared with third parties, according to various implementations of the invention.

In an operation 92, a request from an analyst to share a diligence document of a fund with a third party with whom the analyst shares information may be received. The document access component 134 may receive the request from the analyst to share a diligence document of a fund with a third party with whom the analyst shares information via a fund management portal user interface, by email, and/or by other methods of communication. The document access component 134 may receive the request from a analyst to share a diligence document of a fund with a third party with whom the analyst shares information in a manner the same or similar as that described above.

In an operation 94, acceptable portions of the diligence document may be shared with the third party based on permission settings associated with the fund and with the diligence document. The document access component 134 may share the acceptable portions of the document based on permission settings associated with the fund and with the diligence document. The document access component 134 may share the acceptable portions in a manner the same or similar as that described above.

FIGS. 10A and 10B illustrate an exemplary document shared with third parties, according to various implementations of the invention. In particular, FIG. 10A illustrates an exemplary document shared with a first party whereas FIG. 10B illustrates the exemplary document shared with a second party. The fund management system may receive a request from a first party with whom the user shares information for the first document 1000 with portions A, B, C, D, and E. Based on the set of fund permissions and the set of author permissions associated with the document, the fund management system may output to the first party a document 1000a, with portions A, B, C, and D, as shown in FIG. 10A. The fund management request may also receive a request from a second party with whom the user shares information for the document 1000. Based on the set of fund permission and the set of author permissions, the fund management system may output to the second party a document 1000b, with portions A, C, and D.

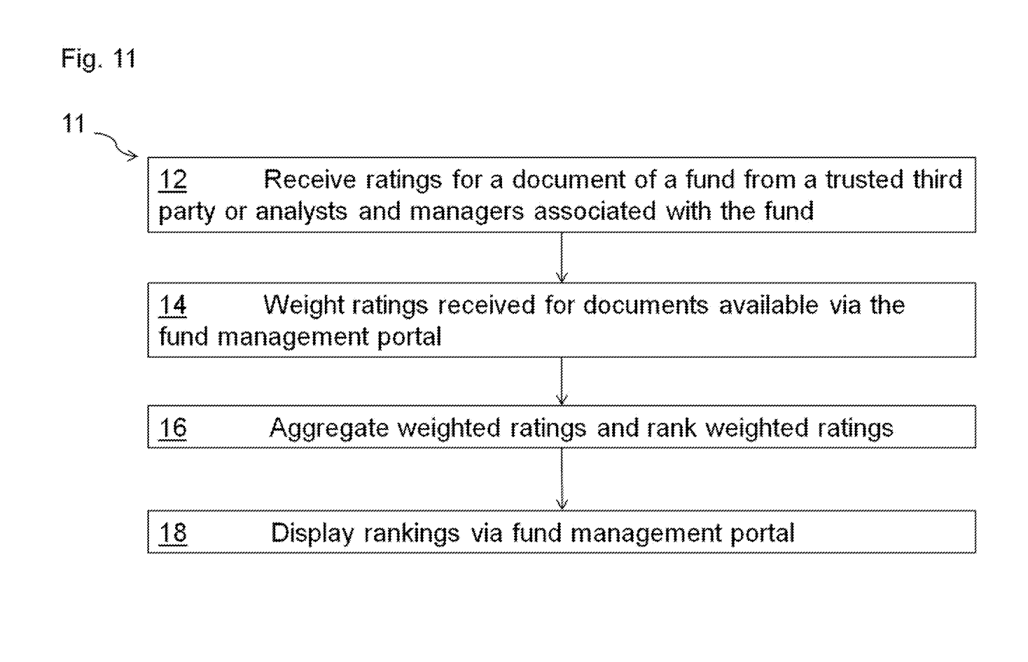

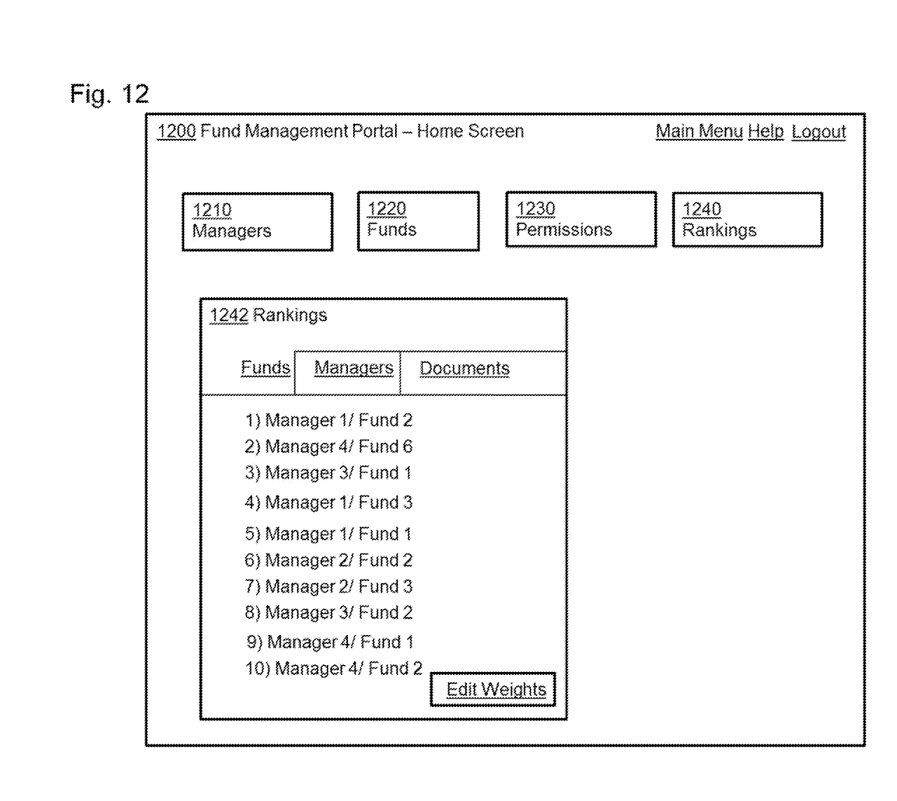

FIG. 11 illustrates a process for receiving and managing ratings for documents via a fund management portal, according to various implementations of the invention. FIG. 12 illustrates an exemplary screen shot of rankings via a fund management portal, according to various implementations of the invention.

In an operation 12, ratings are received for a document of a fund from one or more third parties with whom the user shares information, from one or more analysts, from one or more managers, and/or from other users. The third party ratings component 136 and/or mentor ratings component 138 may receive ratings for the document via a fund management portal user interface, by email, and/or by other methods of communication. The third party ratings component 136 and/or mentor ratings component 138 may receive ratings for the document in a manner the same or similar as that described above.

In an operation 14, the ratings received for the document are weighted. The third party ratings component 136 and/or mentor ratings component 138 may weights the ratings received for the document. The third party ratings component 136 and/or mentor ratings component 138 may weight the ratings in a manner the same or similar as that described above.

In an operation 16, weighted ratings for a plurality of documents available via the fund management system may be aggregated and ranked. For example, all of the documents for which ratings have been received may be aggregated and ranked. In another example, a user-selected set of documents may be aggregated and ranked. The third party ratings component 136 and/or mentor ratings component 138 may aggregate the weighted ratings and rank the weighted ratings. The third party ratings component 136 and/or mentor ratings component 138 may aggregate the weighted ratings and rank the weighted ratings in a manner the same or similar as that described above.

In an operation 18, the rankings of the documents may be displayed. The third party ratings component 136 and/or mentor ratings component 138 may display the rankings for the rated documents via a fund management portal user interface, by email, and/or by other methods of communication. The third party ratings component 136 and/or mentor ratings component 138 may share the acceptable portions in a manner the same or similar as that described above.

In some implementations, ratings of documents, users, funds, third parties, and/or other entities may be aggregated, ranked, and displayed in a manner the same as or similar to that described with FIG. 11.

FIG. 12 illustrates an exemplary screen shot of rankings via a fund management portal, according to various implementations of the invention. In some implementations, user interface 1200 may be presented that includes an exemplary template for a home screen for the fund management portal. The template for the home screen may be presented to a user upon initial access of the system, upon request for the template, and/or responsive to an action by the user. The user interface 1200 may include, for example, manager portion 1210, fund portion 1204, permissions portion 1230, rankings portion 1240, a navigation bar portion, and/or other portions that display information.

The manager portion 1210 may comprise, for example, a selectable link, button, and/or other interactive element via which a user may be presented with another user interface comprising further information about the managers associated with the user. In some implementations, the manager portion 1210 may display information related to the individual managers associated with the user. For example, for an individual manager, the manager portion 1210 may display an identification of the manager, a picture of the manager, the latest ratings and/or feedback received from the manager, whether the manager is a mentor, and/or other information. Some or all of the information displayed for an individual manager may be selectable links, buttons, and/or other interactive elements via which a user may be presented with further information about the selected information.

The fund portion 1220 may comprise, for example, a selectable link, button, and/or other interactive element via which a user may be presented with another user interface comprising further information about the funds associated with the user. In some implementations, the fund portion 1220 may display information related to the individual fund associated with the user. For example, for an individual fund, the fund portion 1220 may display an identification of the fund, an investment theme related to the fund, one or more documents of the fund, the latest ratings and/or feedback received for the fund, and/or other information. Some or all of the information displayed for an individual fund may be selectable links, buttons, and/or other interactive elements via which a user may be presented with further information about the selected information.

The permissions portion 1230 may comprise, for example, a selectable link, button, and/or other interactive element via which a user may be presented with another user interface comprising further information about the permissions associated with the user. In some implementations, the permissions portion 1230 may display information related to the third parties with whom the user shares information. For example, for an individual third party, the permissions portion 1230 may display an identification of the third party, an identification of one or more funds which the third party may access, one or more documents obtained by the third party, the latest ratings and/or feedback received from the third party, and/or other information. Some or all of the information displayed for an individual third party may be selectable links, buttons, and/or other interactive elements via which a user may be presented with further information about the selected information.

In some implementations, the home screen user interface 1200 may display an extended rankings portion 1242. The extended rankings portion may display information related to a rankings for funds, for managers, for documents, and/or for other entities. In some examples, the extended rankings portion 1242 may comprise selectable links, buttons, and/or other interactive elements via which a user may select the entity for which rankings may be displayed. For the entity for which rankings are displayed (e.g., funds), information related to a predetermined number of the top rated funds may be displayed. For example, for an individual fund, the fund portion 1220 may display an identification of the fund, an investment theme related to the fund, one or more documents of the fund, the latest ratings and/or feedback received for the fund, and/or other information. Some or all of the information displayed for an individual fund may be selectable links, buttons, and/or other interactive elements via which a user may be presented with further information about the selected information.

The extended rankings portion 1242 may also display, for each entity, a selectable link, button, and/or other interactive element via which a user may edit the weights by which that entity is ranked. In some implementations, the extended rankings portion 1242 may display an option to edit weights only to a user with a user role of firm administrator or administrator of the fund management system.

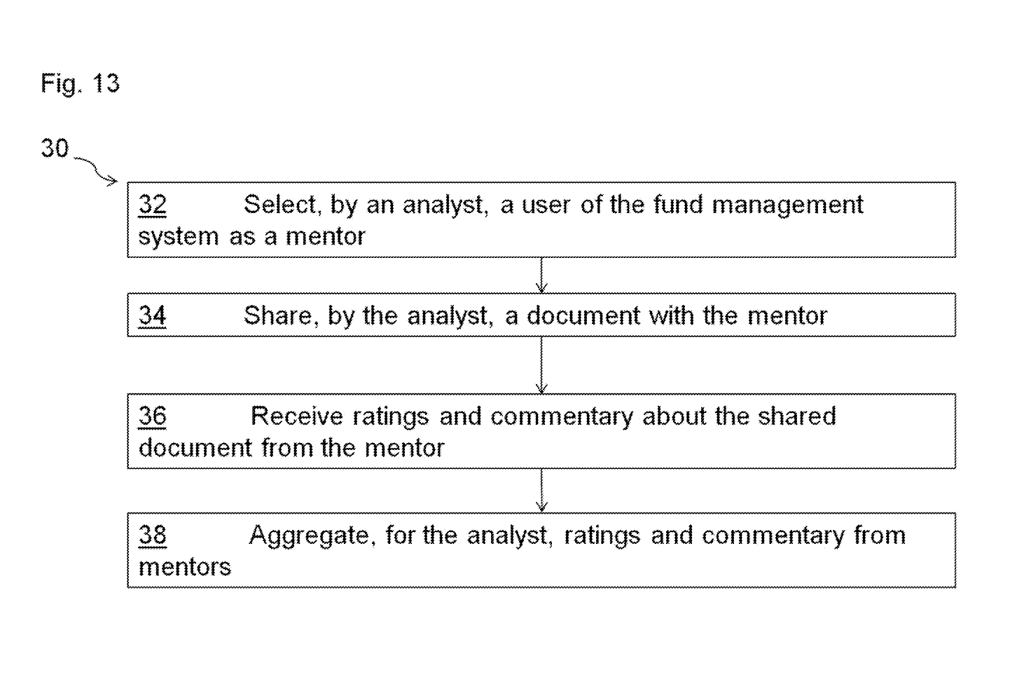

FIG. 13 illustrates a process for receiving and managing feedback from mentors, according to various implementations of the invention.

In an operation 32, an analyst and/or other user may select another user of the fund management system as a mentor. The mentor ratings component 138 may facilitate and receive the selection of a mentor by the user via a fund management portal user interface, by email, and/or by other methods of communication. The mentor ratings component 138 may facilitate and receive the selection of the mentor in a manner the same or similar as that described above.

In an operation 34, an analyst and/or other user may share a document with a mentor. The mentor ratings component 138 may allow the analyst and/or other user to share the document with their mentor via a fund management portal user interface, by email, and/or by other methods of communication. The mentor ratings component 138 may facilitating sharing a document with a mentor in a manner the same or similar as that described above.

In an operation 36, ratings and/or commentary regarding the shared document, the analyst, and/or other entities may be received from the mentor. The mentor ratings component 138 may receive the ratings and/or commentary from the mentor via a fund management portal user interface, by email, and/or by other methods of communication. The mentor ratings component 138 may receive the ratings and/or commentary from the mentor in a manner the same or similar as that described above.

In an operation 38, ratings and/or commentary received from one or more mentors associated with the analyst and/or other user may be aggregated. The mentor ratings component 138 may aggregate received ratings and/or received commentary from one or more mentors associated with the analyst. The mentor ratings component 138 may aggregate the ratings and/or commentary from the one or more mentors associated with the analyst in a manner the same or similar as that described above. In some implementations, the analyst may select the mentors from which ratings and/or commentary are aggregated. In some implementations, the analyst may select documents, document types, funds, and/or other entities for which ratings and/or commentary from the one or more mentors (or the selected set of mentors) are aggregated.

In some implementations, information related to the one or more mentors, ratings from an individual mentor, commentary from an individual mentor, aggregated ratings from one or more mentors, aggregated commentary from one or more mentors, and/or other information related to the one or more mentors associated with the analyst may be available to the analyst via the fund management system 10.

The server 100 may be any computing device such as, for example, a server, a desktop computer, laptop computer, personal digital assistant, smart phone, and/or any other computing device. Other configurations and system architectures may be used. For example, although not shown, server 100 may be or include one or more servers connected to one or more clients via a network 20 such as a Wide Area Network, Local Area Network, the Internet, a cloud-based network and/or other network or combination thereof. The server 100 may be capable of communicating with network 20, non-transitory electronic storage device 200, client devices 300a, 300b, . . . , 300n and/or other computing devices. The server 100 may include a plurality of hardware, software, and/or firmware components operating together to provide the functionality attributed herein to server 100. For example, server 100 may be implemented by a cloud of computing platforms operating together as server 100.

A client device 300n may facilitate communication with the server 100. For example, a user may communicate with the server 100 via a client device 300n. In some implementations, the term user may be interchangeably used herein with the term client device. In some implementations, a user's actions and/or functionality as described herein may be carried out and/or implemented by a client device 300n. A client device 300n may include one or more processors 310n that are configured to execute computer program components. The computer program components may be configured to enable an expert or user associated with the client device 300n to interface with system 10 and/or other components of the system 10, and/or provide other functionality attributed herein to client device 300n. By way of non-limiting example, the client device 300n may include one or more of a desktop computer, a laptop computer, a handheld computer, a tablet computing platform, a NetBook, a Smartphone, a gaming console, and/or other computing platforms. The client device 300n may be capable of communicating with network 20, server 100, non-transitory electronic storage device 200, and/or other computing devices.

The non-transitory electronic storage device 200 may be at least one database that stores system data such as information related to the plurality of funds, information related to the plurality of users, information related to activity performed via the fund management system 10, and/or any other data. The non-transitory electronic storage device 200 may be associated and communicate with the server 100.

The one or more databases comprising the non-transitory electronic storage device 200 may be, include, or interface to, for example, an Oracle™ relational database sold commercially by Oracle Corporation. Other databases, such as Informix™, DB2 (Database 2) or other data storage, including file-based, object, or query formats, platforms, or resources such as OLAP (On Line Analytical Processing), SQL (Standard Query Language), NoSQL, a SAN (storage area network), Microsoft Access™ or other form of database may also be used, incorporated, or accessed. The database may comprise one or more such databases that reside in one or more physical devices and in one or more physical locations. The database may store a plurality of types of data and/or files and associated data or file descriptions, administrative information, or any other data.

In some implementations, the non-transitory electronic storage device 200 may be part of or hosted by a computing device on the network 20. In some implementations, the non-transitory electronic storage device 200 may be part of or hosted by the server 100. In some implementations, the non-transitory electronic storage device 200 may be physically separate from the server 100 but may be operably communicable therewith.

In some implementations, the non-transitory electronic storage device 200 may comprise electronic storage media that electronically stores information. The non-transitory electronic storage device 200 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The non-transitory electronic storage device 200 may include one or more virtual storage resources (e.g., cloud storage, a virtual private network, and/or other virtual storage resources). The non-transitory electronic storage device 200 may store software algorithms, information determined by processor 110, information received from server 100, information received from client devices 300a, 300b, . . . 300n, information received from third parties, and/or other information that enables server 100 to function as described herein.

Processor(s) 110 is configured to provide information processing capabilities in computing device 100. As such, processor 110 may include one or more of a digital processor, an analog processor, a digital circuit designed to process information, an analog circuit designed to process information, a state machine, and/or other mechanisms for electronically processing information. Although processor 110 is shown in FIG. 1 as a single entity, this is for illustrative purposes only. In some implementations, processor 110 may include a plurality of processing units. These processing units may be physically located within the same device, or processor 110 may represent processing functionality of a plurality of devices operating in coordination. The processor 110 may be configured to execute components 120, 130, 140, 150, and/or other components. Processor 110 may be configured to execute components 110, 120, 13, 140, 150, and/or components by software; hardware; firmware; some combination of software, hardware, and/or firmware; and/or other mechanisms for configuring processing capabilities on processor 110.

It should be appreciated that although components 120, 130, 140, 150, and/or other components are illustrated in FIG. 1 as being co-located within a single processing unit, in implementations in which processor 101 includes multiple processing units, one or more of components 120, 130, 140, 150, and/or other components may be located remotely from the other components. The description of the functionality provided by the different components 120, 130, 140, 150, and/or other components described below is for illustrative purposes, and is not intended to be limiting, as any of components 1120, 130, 140, 150, and/or other components may provide more or less functionality than is described. For example, one or more of components 120, 130, 140, 150, and/or other components may be eliminated, and some or all of its functionality may be provided by other ones of components 120, 130, 140, 150, and/or other components. As another example, processor 101 may be configured to execute one or more additional components that may perform some or all of the functionality attributed below to one of components 120, 130, 140, 150, and/or other components.

In addition, implementations of the invention may be made in hardware, firmware, software, or any suitable combination thereof. Aspects of the invention may also be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described herein in terms of specific exemplary aspects and implementations of the invention, and performing certain actions. However, it will be apparent that such descriptions are merely for convenience and that such actions in fact result from computing devices, processors, controllers, or other devices executing the firmware, software, routines, or instructions.

Aspects and implementations described herein as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

1. A computing system for investment fund management configured to facilitate sharing diligence information for a plurality of investment funds, comprising:
a non-transitory electronic storage device configured to store:
a first set of documents relating to a first investment fund managed by a first firm, the first set of documents including a first diligence document;
a first set of fund permissions used to control access to the first set of documents, the first set of fund permissions comprising: a set of document type restrictions that indicates whether particular types of documents from among the first set of documents may be shared;
a first set of author permissions used to control access to a particular document from among the first set of documents based on an authorization from a given author of the particular document; and
one or more physical processors programmed with computer readable instructions to:
receive, from a user associated with the first firm, the first set of fund permissions to control access to the first set of documents;
receive, from a first author who authored the first diligence document and who is different from the user, the first set of author permissions to control access to the first diligence document, the first set of author permissions comprising a document restriction indicating whether the first diligence document may be shared, a first portion restriction indicating whether a first portion of the first diligence document may be shared, and a second portion restriction indicating whether a second portion of the first diligence document may be shared;
receive, from a first client, a request to access the information related to the first investment fund;
determine, from the first set of documents relating to the first investment fund, a first subset of documents to share with the first client based on the first set of fund permissions comprising the set of document type restrictions responsive to the request, wherein the first subset of documents includes the first diligence document;
output, for the first client, information relating to the first subset of documents;
receive, from the first client, a request to access the first diligence document;
determine, based on the first set of author permissions for the first diligence document, whether the first client has permission to access the first diligence document; and
responsive to a determination that the first client has permission to access the first diligence document based on the first set of author permissions, output, to the first client, the first diligence document.

2. The system of claim 1, wherein to output the first diligence document, the one or more processors are programmed with computer readable instructions to:
output a first portion of the first diligence document based on the first set of fund permissions for the first diligence document and the first set of author permissions for the first diligence document; and
prevent output of a second portion of the first diligence document to the first client based on the first set of fund permissions for the first diligence document and the first set of author permissions for the first diligence document.

3. The system of claim 1, wherein the one or more processors are programmed with computer readable instructions to:
add the first client to a fund user list associated with the first set of fund permissions;
add the first client to an author user list associated with the first set of author permissions;
receive information related to the set of author permissions for the first client; and
responsive to the information related to the first set of author permissions for the first client comprising a first portion restriction, adding the first client to a user list associated with the first portion restriction of the first set of author permissions for the first diligence document.

4. The system of claim 1, wherein the one or more processors are programmed with computer readable instructions to:
output, to a second client, information related to the first diligence document based on the first set of fund permissions for the first investment fund;
receive, from a second client, a request to access the first diligence document;
determine, based on the first set of author permissions for the first diligence document, whether the second client has permission to access the first diligence document; and
responsive to a determination that the second client has permission to access the first diligence document based on the first set of author permissions, output, to the second client, the first diligence document.

5. The system of claim 4, wherein to output the first diligence document, the one or more processors are programmed to:
output the first portion of the first diligence document based on the first set of fund permissions for the first diligence document and the first set of author permissions for the first diligence document; and
output the second portion of the first diligence document based on the first set of fund permissions for the first diligence document and the first set of author permissions for the first diligence document.

6. The system of claim 1, wherein the one or more processors are programmed with computer readable instructions to:
facilitate access, for the first author, to a first set of client documents of the first client responsive to receiving the request to access information related to the first investment fund from the first client, the first set of client documents comprising a first client document.

7. The system of claim 6, wherein the one or more processors are programmed with computer readable instructions to:
output information related to a list of funds associated with the first author, the list of funds comprising the first investment fund and a second investment fund;
output information related to a list of shared documents, the shared documents comprising the first client document from the first set of client documents and a second diligence document of a second set of documents for the second investment fund shared with the first author by a second author of the second diligence document.

8. The system of claim 1, wherein the one or more processors are programmed with computer readable instructions to:
receive, from the first author, an identification of another user as a mentor; and
receive, from the mentor, one or more of feedback and a rating for the first author.

9. The system of claim 8, wherein the received rating for the first author comprises a rating of the first diligence document of the first author.

10. The system of claim 9, wherein the one or more processors are programmed with computer readable instructions to:
receive a second rating from a second user for the first diligence document;
aggregate the received ratings for the first diligence document; and
output, to the first author, information related to the aggregated received ratings.

11. (canceled)

12. The system of claim 1, wherein to determine whether the first client has permission to access the first diligence document, the one or more processors are programmed to:
determine whether an identification of the first client is included in a user list associated with the first set of author permissions for the first diligence document.

13. The system of claim 1, wherein to determine whether the first client has permission to access the first diligence document, the one or more processors are programmed to:
determine whether a user role of the first client is included in a user list associated with the first set of author permissions for the first diligence document.

14. A method for investment fund management configured to facilitate sharing diligence information for a plurality of investment funds, the method being implemented in a computer system comprising a non-transitory electronic storage device and one or more physical processors programmed with computer readable instructions, the method comprising:
storing, at the non-transitory electronic storage device, a first set of documents relating to a first investment fund managed by a first firm, the first set of documents including a first diligence document; and
storing, at the non-transitory electronic storage device, a first set of fund permissions used to control access to the first set of documents, the first set of fund permissions comprising:
a set of document type restrictions that indicates whether particular types of documents from among the first set of documents may be shared;
storing, at the non-transitory electronic storage device, a first set of author permissions used to control access to a particular document among the first set of documents based on an authorization from a given author of the particular document; and
receiving, by the one or more physical processors, from a user associated with the first firm, the first set of fund permissions to control access to the first set of documents;
receiving, by the one or more physical processors, from a first author who authored the first diligence document and who is different from the user, the first set of author permissions to control access to the first diligence document, the first set of author permissions comprising a document restriction indicating whether the first diligence document may be shared, a first portion restriction indicating whether a first portion of the first diligence document may be shared, and a second portion restriction indicating whether a second portion of the first diligence document may be shared;
receiving, by the one or more physical processors, from a first client, a request to access the information related to the first investment fund;
determining, by the one or more physical processors, from the first set of documents, a first subset of documents to share with the first client based on the first set of fund permissions comprising the set of document type restrictions responsive to the request, wherein the first subset of documents includes the first diligence document;
outputting, by the one or more physical processors, for the first client, information relating to the first subset of documents;
receiving, by the one or more physical processors, from the first client, a request to access the first diligence document;
determining, by the one or more physical processors, based on the first set of author permissions for the first diligence document, whether the first client has permission to access the first diligence document; and
responsive to a determination that the first client has permission to access the first diligence document based on the first set of author permissions, outputting, by the one or more physical processors, to the first client, the first diligence document.

15. The method of claim 14, wherein outputting the first diligence document to the first client comprises:
outputting, by the one or more physical processors, a first portion of the first diligence document based on the first set of fund permissions for the first diligence document and the first set of author permissions for the first diligence document; and
preventing, by the one or more physical processors, output of a second portion of the first diligence document to the first client based on the first set of fund permissions for the first diligence document and the first set of author permissions for the first diligence document.

16. The method of claim 14, further comprising:
adding, by the one or more physical processors, the first client to a fund user list associated with the first set of fund permissions;
adding, by the one or more physical processors, the first client to an author user list associated with the first set of author permissions;
receiving, by the one or more physical processors, information related to the set of author permissions for the first client; and
responsive to the information related to the set of author permissions for the first client comprising a first portion restriction, adding, by the one or more physical processors, the first client to a user list associated with the first portion restriction of the first set of author permissions for the first diligence document.

17. The method of claim 14, further comprising:
outputting, by the one or more physical processors, to a second client, information related to the first diligence document based on the first set of fund permissions for the first investment fund;
receiving, by the one or more physical processors, from a second client, a request to access the first diligence document;
determining, based on the first set of author permissions for the first diligence document, whether the second client has permission to access the first diligence document; and
responsive to a determination that the second client has permission to access the first diligence document based on the first set of author permissions, outputting, by the one or more physical processors, to the second client, the first diligence document.

18. The method of claim 17, wherein outputting the first diligence document to the second client comprises:
outputting, by the one or more physical processors, the first portion of the first diligence document based on the first set of fund permissions for the first diligence document and the first set of author permissions for the first diligence document; and
outputting, by the one or more physical processors, the second portion of the first diligence document based on the first set of fund permissions for the first diligence document and the first set of author permissions for the first diligence document.

19. The method of claim 14, further comprising:
facilitating, by the one or more physical processors, access, for the first author, to a first set of client documents of the first client responsive to receiving the request to access information related to the first investment fund from the first client, the first set of client documents comprising a first client document.

20. The method of claim 19, further comprising:
outputting, by the one or more physical processors, information related to a list of funds associated with the first author, the list of funds comprising the first investment fund and a second investment fund;
outputting, by the one or more physical processors, information related to a list of shared documents, the shared documents comprising the first client document from the first set of client documents and a second diligence document of a second set of documents for the second investment fund shared with the first author by a second author of the second diligence document.

21. The method of claim 14, further comprising:
receiving, by the one or more physical processors, from the first author, an identification of another user as a mentor; and
receiving, by the one or more physical processors, from the mentor, one or more of feedback and a rating for the first author.

22. The method of claim 21, wherein the received rating for the first author comprises a rating of the first diligence document of the first author.

23. The method of claim 22, further comprising:
receiving, by the one or more physical processors, a second rating from a second user for the first diligence document;
aggregating, by the one or more physical processors, the received ratings for the first diligence document; and
outputting, by the one or more physical processors, to the first author, information related to the aggregated received ratings.

24. (canceled)

25. The method of claim 14, wherein determining whether the first client has permission to access the first diligence document comprises:
determining, by the one or more physical processors, whether an identification of the first client is included in a user list associated with the first set of author permissions for the first diligence document.

26. The method of claim 14, wherein determining whether the first client has permission to access the first diligence document comprises:
determining, by the one or more physical processors, whether a user role of the first client is included in a user list associated with the first set of author permissions for the first diligence document.

27. A computing system for investment fund management configured to facilitate sharing diligence information for a plurality of investment funds, comprising:
a non-transitory electronic storage device configured to store:
a first set of documents relating to a first investment fund managed by a first firm, the first set of documents including a first diligence document;
a first set of client documents associated with a first client; and
a first set of fund permissions used to provide multi-level access control of information related to the first investment fund, the first set of fund permissions comprising: (i) a set of document type restrictions that indicates whether particular types of documents from among the first set of documents may be shared, and (ii) a set of author permissions that indicates whether a particular document from among the first set of documents has been authorized by a given author of the particular document to be shared; and
one or more physical processors programmed with computer readable instructions to:
receive, from a first author who authored the first diligence document, a first set of author permissions for the first diligence document, the first set of author permissions comprising a document restriction indicating whether the first diligence document may be shared, a first portion restriction indicating whether a first portion of the first diligence document may be shared, and a second portion restriction indicating whether a second portion of the first diligence document may be shared, wherein the first set of author permissions grants the first client access to the first diligence document;
responsive to receipt of the first set of author permissions, grant the first author with access to the first set of client documents in exchange for the access granted by the first author to the first client;
receive, from the first client, a request to access the information related to the first investment fund;
determine, from the first set of documents relating to the first investment fund, a first subset of documents to share with the first client based on the set of document type restrictions responsive to the request, wherein the first subset of documents includes the first diligence document;
output, for the first client, information relating to the first subset of documents;
receive, from the first client, a request to access the first diligence document; and
determine, based on the first set of author permissions for the first diligence document, whether the first client has permission to access the first diligence document.

28. The system of claim 27, wherein the one or more processors are programmed with computer readable instructions to:
output, to the first client, a first portion of the first diligence document based on the first set of fund permissions for the first diligence document and the first set of author permissions for the first diligence document; and
prevent output of a second portion of the first diligence document to the first client based on the first set of fund permissions for the first diligence document and the first set of author permissions for the first diligence document.

29. A method for investment fund management configured to facilitate sharing diligence information for a plurality of investment funds, the method being implemented in a computer system comprising a non-transitory electronic storage device and one or more physical processors programmed with computer readable instructions, the method comprising:
storing, at the non-transitory electronic storage device, a first set of documents relating to a first investment fund managed by a first firm, the first set of documents including a first diligence document;
storing, at the non-transitory electronic storage device, a first set of client documents associated with a first client; and
storing, at the non-transitory electronic storage device, a first set of fund permissions used to provide multi-level access control of the information related to the first investment fund, the first set of fund permissions comprising: (i) a set of document type restrictions that indicates whether particular types of documents from among the first set of documents from among the first set of documents may be shared, and (ii) a set of author permissions that indicates whether a particular document among the first set of documents has been authorized by a given author of the particular document to be shared; and
receiving, by the one or more physical processors, from a first author who authored the first diligence document, a first set of author permissions for the first diligence document, the first set of author permissions comprising a document restriction indicating whether the first diligence document may be shared, a first portion restriction indicating whether a first portion of the first diligence document may be shared, and a second portion restriction indicating whether a second portion of the first diligence document may be shared, wherein the first set of author permissions grants the first client access to the first diligence document;
responsive to receipt of the first set of author permissions, granting, by the one or more physical processors, the first author with access to the first set of client documents in exchange for the access granted by the first author to the first client;
receiving, by the one or more physical processors, from the first client, a request to access the information related to the first investment fund;
determining, by the one or more physical processors, from the first set of documents relating to the first investment fund, a first subset of documents to share with the first client based on the set of document type restrictions responsive to the request, wherein the first subset of documents includes the first diligence document;
outputting, by the one or more physical processors, for the first client, information relating to the first subset of documents;
receiving, by the one or more physical processors, from the first client, a request to access the first diligence document; and
determining, by the one or more physical processors, based on the first set of author permissions for the first diligence document, whether the first client has permission to access the first diligence document.

30. The method of claim 29, further comprising:
outputting, by the one or more physical processors, to the first client, a first portion of the first diligence document based on the first set of fund permissions for the first diligence document and the first set of author permissions for the first diligence document; and
preventing, by the one or more physical processors, output of a second portion of the first diligence document to the first client based on the first set of fund permissions for the first diligence document and the first set of author permissions for the first diligence document.
